(19) United States
(12) Patent Application Publication
(10) Pub. No.: US 2025/0029992 A1
(43) Pub. Date: Jan. 23, 2025

(54) SECONDARY BATTERY, BATTERY PACK AND VEHICLE

(71) Applicant: KABUSHIKI KAISHA TOSHIBA, Tokyo (JP)

(72) Inventors: Norio TAKAMI, Yokohama (JP); Yuiko KOITABASHI, Yokohama (JP); Kakuya UEDA, Kawasaki (JP)

(73) Assignee: KABUSHIKI KAISHA TOSHIBA, Tokyo (JP)

(21) Appl. No.: 18/588,085

(22) Filed: Feb. 27, 2024

(30) Foreign Application Priority Data
Jul. 21, 2023 (JP) 2023-119253
Feb. 21, 2024 (JP) 2024-024648

(51) Int. Cl. H01M 4/485; H01M 4/02; H01M 4/66; H01M 10/0569; H01M 50/209; H01M 50/296; H02J 7/00

(52) U.S. Cl. CPC H01M 4/485; H01M 4/661; H01M 10/0569; H01M 50/209; H01M 50/296; H02J 7/007194; H01M 2004/027; H01M 2004/028; H01M 2200/10; H01M 2220/20

(57) ABSTRACT

In general, according to one embodiment, a secondary battery includes a positive electrode, a negative electrode, and a nonaqueous electrolyte. The nonaqueous electrolyte includes a nonaqueous solvent and an electrolyte. The nonaqueous solvent includes a first solvent including at least one selected from the group consisting of ethyl propionate, propyl propionate and ethyl butyrate, and a second solvent including γ-butyrolactone. The electrolyte includes lithium bisfluorosulfonylimide.

### CROSS-REFERENCE TO RELATED APPLICATIONS

This application is based upon and claims the benefit of priority from Japanese Patent Applications No. 2023-119253, filed Jul. 21, 2023, and No. 2024-024648, filed Feb. 21, 2024, the entire contents of all of which are incorporated herein by reference.

### FIELD

Embodiments described herein relate generally to a secondary battery, a battery pack, and a vehicle.

### BACKGROUND

Nonaqueous electrolyte batteries using lithium metal, a lithium alloy, a lithium compound, or a carbonaceous material as their negative electrodes are expected to be high energy density batteries, and research and development thereon are actively promoted. A lithium-ion battery which includes: a positive electrode including LiCoO₂ or LiMn₂O₄ as an active material; and a negative electrode including a carbonaceous material which allows lithium ions to be inserted in and to be extracted from has been widely put to practical use for portable devices so far.

On the other hand, in a case of being mounted in a vehicle such as an automobile or a train, in order to satisfy battery performance (for example, storage performance, cycle performance, and high power) in a high-temperature environment (for example, 60° C. or higher), the constituent materials for the positive electrode and the negative electrode are desirably excellent in chemical and electrochemical stability, strength, and corrosion resistance. Furthermore, in order to realize high performance in cold regions, improvement in battery performance (for example, high current performance and long life performance) in a low-temperature environment (for example, −40° C.) is required. On the other hand, nonvolatile and non-flammable electrolytic solutions are being developed as nonaqueous electrolytes from the viewpoint of improving safety performance, but they are still not in practical use due to the deterioration in output properties, low-temperature performance, or long-life performance.

The above problem is a barrier to use of a lithium-ion battery mounted in an engine room of an automobile as an alternative to a lead storage battery. In order to mount the lithium-ion battery in a vehicle or the like, improvement in high-temperature durability and high current performance is desired.

### BRIEF DESCRIPTION OF THE DRAWINGS

FIG. 1 is a partially cutaway cross-sectional view of a secondary battery of an embodiment.

FIG. 2 is a side view of the battery of FIG. 1.

FIG. 3 is a cross-sectional view cutting the secondary battery of the embodiment in a direction perpendicular to an extending direction of a terminal.

FIG. 4 is an enlarged cross-sectional view of the part A of FIG. 3.

FIG. 5 is a perspective view showing an example of a battery module including the secondary battery of the embodiment.

FIG. 6 is an exploded perspective view of a battery pack of the embodiment.

FIG. 7 is a block diagram showing an electric circuit of the battery pack of FIG. 6.

FIG. 8 is a schematic drawing showing an example of a vehicle mounted with the secondary battery of the embodiment.

FIG. 9 is a view schematically showing another example of a vehicle according to the embodiment.

### DETAILED DESCRIPTION

In general, according to an embodiment, a secondary battery includes a positive electrode, a negative electrode, and a nonaqueous electrolyte. The nonaqueous electrolyte includes a nonaqueous solvent and an electrolyte. The nonaqueous solvent includes a first solvent including at least one selected from the group consisting of ethyl propionate, propyl propionate and ethyl butyrate, and a second solvent including γ-butyrolactone. The electrolyte includes lithium bisfluorosulfonylimide.

According to an embodiment, a battery pack includes the secondary battery of the embodiment.

According to an embodiment, a vehicle includes at least one of the secondary battery or the battery pack of the embodiment.

### First Embodiment

According to the first embodiment, there is provided a secondary battery including a positive electrode, a negative electrode, and a nonaqueous electrolyte. The nonaqueous electrolyte contains a nonaqueous solvent and an electrolyte. The nonaqueous solvent contains a first solvent including at least one selected from the group consisting of ethyl propionate (EP), propyl propionate (PP), and ethyl butyrate (EB), and a second solvent including γ-butyrolactone. The electrolyte contains lithium bisfluorosulfonylimide (LiN(FSO₂)₂:LiFSI).

It has been studied to achieve high current discharge performance, low-temperature performance, and high-temperature life performance by improving a nonaqueous electrolyte. A nonaqueous electrolyte having high ion conductivity in a low-temperature region tends to easily react with the positive electrode at a high temperature, and thus makes it difficult to obtain excellent life performance. Therefore, a nonaqueous electrolyte having the conventional composition has made it difficult to achieve high current discharge performance, low-temperature performance, and high-temperature life performance.

In a case where a secondary battery including a positive electrode including a positive electrode current collector containing at least one of aluminum or an aluminum alloy has a high voltage such that a positive electrode potential reaches 4 V (vs. Li/Li⁺) or more in a high-temperature environment, the positive electrode current collector corrodes and melts, and a positive electrode active material-containing layer is peeled off from the positive electrode current collector. As a result, it becomes difficult to charge and discharge the secondary battery, resulting in deterioration in life performance. As a result of intensive studies, the present inventors have found for the first time that by using a nonaqueous electrolyte containing a nonaqueous solvent containing a first solvent including at least one selected from the group consisting of ethyl propionate (EP), propyl propionate (PP) and ethyl butyrate (EB) and a second solvent including γ-butyrolactone (GBL), and an electrolyte containing lithium bisfluorosulfonylimide (LiFSI), a secondary battery that can suppress corrosion of a positive electrode current collector and is excellent in high current performance, low-temperature performance and high-temperature life performance can be obtained. According to the secondary battery of the embodiment, excellent high current performance and durability performance can be realized in a wide range of temperatures from a low temperature (for example, −70° C.) to a high temperature (for example, 70° C.). The detailed mechanism is not clear, but is presumed as follows.

The nonaqueous electrolyte having the above composition can suppress corrosion of the positive electrode current collector. Since LiFSI has high solubility in GBL as the second solvent and can be dissolved to a high concentration, the ion conductivity of the nonaqueous electrolyte can be increased, and high current performance such as high current discharge performance of the secondary battery can be improved. In addition, since LiFSI is chemically stable at a high temperature in the nonaqueous electrolyte having the above composition, the life performance of the secondary battery at a high temperature can be improved. On the other hand, since the first solvent can reduce the viscosity of the nonaqueous electrolyte, the low-temperature performance of the secondary battery can be improved. In addition, the first solvent can enhance the electrochemical stability of the nonaqueous electrolyte at a high voltage and a high temperature. Therefore, the electrochemical stability of the nonaqueous electrolyte against the high-voltage positive electrode can be enhanced, and the life performance of the secondary battery that can be used in a charged state at a high voltage and a high temperature can be improved.

Therefore, a nonaqueous electrolyte in which LiFSI is dissolved in a nonaqueous mixed solvent containing the first solvent and the second solvent can provide a secondary battery excellent in high current performance, low-temperature performance, and high-temperature life performance.

Hereinafter, the nonaqueous electrolyte, the positive electrode, and the negative electrode will be described.

### (Nonaqueous Electrolyte)

The nonaqueous electrolyte contains a nonaqueous solvent containing a first solvent including at least one selected from the group consisting of ethyl propionate (EP), propyl propionate (PP) and ethyl butyrate (EB) and a second solvent including γ-butyrolactone (GBL), and an electrolyte containing lithium bisfluorosulfonylimide (LiFSI). The electrolyte is dissolved in the nonaqueous solvent.

The first solvent is a nonaqueous solvent that is excellent in low-temperature performance due to its low viscosity and is electrochemically stable even at a high voltage and a high temperature. Propyl propionate and ethyl butyrate have a low melting point and a high flash point, and belong to Class II petroleums. The first solvent substantially including at least one of propyl propionate or ethyl butyrate is easy to handle and can enhance mass productivity of the secondary battery.

The second solvent is a nonaqueous solvent containing γ-butyrolactone. LiFSI has high solubility in γ-butyrolactone and excellent chemical stability against γ-butyrolactone. The second solvent may include only γ-butyrolactone or may contain a nonaqueous solvent other than γ-butyrolactone (hereinafter, referred to as a third solvent). Examples of the third solvent include propylene carbonate (PC), ethylene carbonate (EC), diethyl carbonate (DEC), methyl-ethyl-carbonate (MEC), dimethyl carbonate (DMC), and trimethyl phosphate (TMP). TMP has an extinguishing action, and thus, when added, can make the electrolytic solution flame retardant. Since propylene carbonate is stable against a high voltage, the stability of the nonaqueous electrolyte at a high voltage can be enhanced. In addition, since propylene carbonate can form a film at at least a part of a surface of a negative electrode active material-containing layer, a reaction between a negative electrode active material and the nonaqueous electrolyte and a reaction between a conductive agent and the nonaqueous electrolyte can be suppressed. As a result, gas generation at a high temperature can be suppressed. The amount of the third solvent can be 5% by volume or more and 30% by volume or less in a total nonaqueous mixed solvent. This can improve cycle life performance of the secondary battery.

A mixing ratio between the first solvent and the second solvent in the nonaqueous mixed solvent is preferably in the range of 9:1 to 1:3 in a volume ratio represented as first solvent: second solvent. Within this range, a secondary battery excellent in high current discharge performance, low-temperature discharge performance, and high-temperature cycle performance can be realized. A more preferable range of the volume ratio is 4:1 to 1:2. Examples of preferred non-aqueous mixed solvent compositions are GBL and EP; GBL and PP; GBL and EB; GBL, EP and PP; GBL, PP and EB; GBL, PC and EP; GBL, PC and PP; GBL, PC and EB; GBL, EP and TMP; and GBL, PP and TMP.

A concentration of LiFSI in the nonaqueous electrolyte can be 0.8 M (mol/L) or more and 4 M (mol/L) or less. By setting the volume ratio within this range, the nonaqueous electrolyte can have high ionic conductivity in a range from a low temperature to a high temperature, so that the high current discharge performance of the secondary battery can be improved. By increasing the LiFSI concentration, generation of a nitrogen-containing substance derived from LiFSI can be promoted. On the other hand, the reduction in LiFSI concentration can promote the generation of a nitrogen-containing substance derived from a nitric acid compound while increasing the ion conductivity of the nonaqueous electrolyte. A preferred range of the LiFSI concentration as the electrolyte is 0.8 M or more and 3 M or less. A more preferable range is 1 M or more and 2 M or less.

The electrolyte can be dissolved in the nonaqueous solvent. The electrolyte may substantially include LiFSI, but may contain an electrolyte other than LiFSI (hereinafter, referred to as a second electrolyte). Examples of the second electrolyte include LiBF₄ and LiN(CF₃SO₂)₂. LiBF₄ has high chemical stability against GBL, and can form an aluminum fluoride (AlF₃) layer at the surface of the positive electrode current collector. Since the aluminum fluoride layer can suppress corrosion of the positive electrode current collector without inhibiting lithium ion conduction in the positive electrode, the high-temperature life performance of the secondary battery can be improved. A concentration of the second electrolyte in the nonaqueous electrolyte can be 0.1 M or more and 0.5 M or less.

The nonaqueous electrolyte may contain at least one compound selected from the group consisting of a nitrogen-containing compound, a sulfur-containing compound, a boron-containing compound, a phosphorus-containing compound, and a fluorine-containing compound. As a result, since a film-like substance or a layered substance can be formed at at least one of the positive electrode or the negative electrode, excellent cycle life performance can be realized not only at around ordinary temperatures but also at high temperatures. The content of the at least one compound in the nonaqueous electrolyte can be 0.1% by weight or more and 10% by weight or less. A more preferable range of the content is 0.5% by weight or more and 10% by weight or less.

Examples of the nitrogen-containing compound can include a nitrate. The nitrate can be, for example, a salt that is dissolved in the nonaqueous electrolyte to provide NO₃⁻ ions. Examples of the nitrate include LiNO₃, NaNO₃, and KNO₃. The type of the nitrate used may be one or two or more. The nitrate can form a nitrogen-containing substance at at least a part of the surface of the positive electrode current collector even at a low concentration of LiFSI in the nonaqueous electrolyte. Among the nitrates, LiNO₃ is desirable. It is possible to form a nitrogen-containing substance at at least a part of the surface of the positive electrode current collector even in a case where the concentration of LiFSI in the nonaqueous electrolyte is increased without incorporation of a nitrate. The nitrogen-containing substance may exist as a film (for example, a coating film) at the surface of the positive electrode current collector. Since the nitrogen-containing substance can suppress corrosion of the positive electrode current collector at a high potential and a high temperature, peeling of the positive electrode active material-containing layer from the positive electrode current collector can be suppressed. The nitrogen-containing substance may also be present at at least a part of the surface of at least one of the positive electrode active material-containing layer or the negative electrode active material-containing layer. The nitrogen-containing substance may be a nitrogen-containing inorganic substance. Examples of the nitrogen-containing inorganic substance can include a nitric acid compound and a metal nitride such as Li₃N. Since the metal nitride such as Li₃N has lithium ion conductivity, resistance of the film containing the nitrogen-containing substance can be reduced. Therefore, the metal nitride can improve high current performance. On the other hand, the nitric acid compound can suppress decomposition of the nonaqueous electrolyte. The nitrate can form a nitrogen-containing substance containing at least one of a nitric acid compound or a metal nitride. Also, the nitrate can form a nitrogen-containing substance without affecting the ion conductivity of the nonaqueous electrolyte.

Examples of the sulfur-containing compound can include 1,3-propane sultone (PS). The 1,3-propane sultone can form a film containing S at at least a part of the surface of either the positive electrode active material-containing layer or the negative electrode active material-containing layer, or both of the layers. As a result, the decomposition of the nonaqueous solvent can be suppressed, so that gas generation at a high temperature can be suppressed.

Examples of the boron-containing compound can include lithium difluoro (oxalato) borate (LiBF₂C₂O₄: LiDFOB), lithium bis (oxalate) borate (LiB(C₂O₄)₂: LiBOB), and lithium tetrafluoroborate (LiBF₄). In a case where the positive electrode current collector contains Al, each of LiDFOB and LiBF₄ can form a film containing boron (B), oxygen (O), fluorine (F), and aluminum (Al) at the surface of the positive electrode current collector. As a result, no matter whether the LiFSI concentration in the nonaqueous electrolyte is low or high, or even at a high voltage or a high temperature, it is possible to suppress a dissolution reaction due to corrosion of Al. This film desirably contains a substance with an Al—F bond, a B—O bond, and a B—F bond. Thereby, it is possible to improve the charge-and-discharge cycle performance of the battery.

The content of the boron-containing compound in the nonaqueous electrolyte is preferably 0.1% by weight or more and 5% by weight or less. By setting the content to be 0.1% by weight or more, it is possible to form the B-containing film at the surface of the positive electrode current collector. As a result, it is possible to suppress dissolution due to corrosion of the positive electrode current collector. By setting the content to be 5% by weight or less, the ionic conductivity of the nonaqueous electrolyte can be increased.

Also, the boron-containing compound can form a B-containing film at the surface of the negative electrode active material. Since a B-containing film is stable, the reductive decomposition of the nonaqueous electrolyte can be suppressed. As a result, the charge-and-discharge efficiency of the negative electrode can be enhanced, so that the cycle life performance of the battery can be improved.

Examples of the phosphorus-containing compound can include tris(trimethylsilyl) phosphate (TMSP). TMSP can form a film containing P at at least a part of the surface of either the positive electrode active material-containing layer or the negative electrode active material-containing layer, or both of the layers. As a result, the decomposition of the nonaqueous solvent can be suppressed, so that gas generation at a high temperature can be suppressed.

Examples of the fluorine-containing compound can include fluoroethylene carbonate (FEC). FEC can form a film containing F at at least a part of the surface of either the positive electrode active material-containing layer or the negative electrode active material-containing layer, or both of the layers. As a result, the decomposition of the nonaqueous solvent can be suppressed, so that gas generation at a high temperature can be suppressed. Also, since an F-containing film can suppress reductive decomposition of GBL of the nonaqueous solvent at the surface of the negative electrode active material, the cycle life performance of the battery can be improved.

The form of the nonaqueous electrolyte is not particularly limited, and can be, for example, liquid, gel, solid, or the like. The liquid nonaqueous electrolyte substantially includes a nonaqueous solvent and an electrolyte dissolved in the nonaqueous solvent. The gel or solid nonaqueous electrolyte may be a product obtained by compositing a liquid nonaqueous electrolyte and a polymer material, in other words, a composite of a liquid nonaqueous electrolyte and a polymer material. Examples of the polymeric material can include polyvinylidene fluoride (PVdF), polyacrylonitrile (PAN), and polyethylene oxide (PEO).

The nonaqueous electrolyte may contain an ordinary temperature molten salt including a nonvolatile and non-flammable ionic liquid. The liquid nonaqueous electrolyte can improve the low-temperature performance of the secondary battery.

An example of a first method for forming a film-like substance or a layered substance at at least one of the positive electrode or the negative electrode will be described below. At least one compound selected from the group consisting of a nitrogen-containing compound, a sulfur-containing compound, a boron-containing compound, a phosphorus-containing compound, and a fluorine-containing compound is added to a nonaqueous electrolyte in an amount of 0.1 to 10% by weight, a secondary battery including the nonaqueous electrolyte, a positive electrode, and a negative electrode is assembled, and then a battery charged to a positive electrode potential of 4 V (vs. Li/Li⁺) or more is applied to an aging treatment at a temperature of 45 to 80° C., so that a film-like substance or a layered substance can be formed at the electrode. The film-like substance and the layered substance contain at least one element (atom) selected from the group consisting of N, S, B, P, and F.

The positive electrode and the negative electrode used in assembling the secondary battery can be produced, for example, by the following method. The positive electrode is produced, for example, by suspending a positive electrode active material, a conductive agent and a binder in a suitable solvent, applying the suspension to a positive electrode current collector, and drying and pressing it. On the other hand, the negative electrode is produced, for example, by suspending a negative electrode active material, a conductive agent and a binder in an appropriate solvent, applying the suspension to a current collector, drying it, and pressing it.

### (Negative Electrode)

The negative electrode includes a negative electrode current collector and a negative electrode active material-containing layer that is carried on or is in contact with one surface or both surfaces of the negative electrode current collector and contains a negative electrode active material. The negative electrode active material-containing layer may contain either a binder or a conductive agent, or both of them.

The negative electrode active material can be, for example, a material that allows Li (for example, lithium ions) to be inserted in and to be extracted from. Examples of the material that allows Li (for example, lithium ions) to be inserted in and to be extracted from include carbon materials, metal oxides, metal sulfides, and Li alloys. The type of the negative electrode active material used may be one or two or more.

Examples of the carbon material can include graphite, carbon fiber, coke, and hardly-graphitizable carbon. Examples of the metal sulfide can include titanium sulfide, molybdenum sulfide, and iron sulfide. Examples of the Li alloy can include an alloy containing Li and at least one element selected from the group consisting of Si, Al, Sn, Zn, and Pb.

The metal oxide can be, for example, a metal oxide that allows lithium ions to be inserted in and to be extracted from at a potential of 0.5 V (vs. Li/Li⁺) or more and 3.0 V (vs. Li/Li⁺) or less. Examples of the metal oxide include titanium-containing oxides and niobium-containing oxides. In the negative electrode containing the negative electrode active material containing at least one of the titanium-containing oxide or the niobium-containing oxide, the insertion/extraction potential of lithium ions is 0.5 to 3.0 V (vs. Li/Li⁺), and thus a stable film can be formed at a high temperature at the surface of the negative electrode active material-containing layer. Therefore, since reductive decomposition of the nonaqueous electrolyte can be suppressed, a nonaqueous electrolyte secondary battery having excellent life performance in a high-temperature environment can be obtained. A more preferable negative electrode potential range is 0.7 (vs. Li/Li⁺) or more and 2 V (vs. Li/Li⁺) or less.

Examples of the titanium-containing oxide include lithium titanium-containing oxides and titanium oxides. Examples of the niobium-containing oxide include niobium titanium-containing oxides, niobium tungsten-containing oxides, and niobium titanium molybdenum-containing oxides.

Examples of the lithium titanium-containing oxide include those having a spinel structure (for example, the general formula: Li_{4/3+a}Ti_{5/3}O₄ (0≤a≤2)), those having a ramsdellite structure (for example, the general formula Li₂₊ₐTi₃O₇ (0≤a≤1)), a lithium titanium-containing oxide represented by Li_{1+b}Ti₂O₄(0≤b≤1), a lithium titanium-containing oxide represented by Li_{1.1+b}Ti_{1.8}O₄ (0≤b≤1), a lithium titanium-containing oxide represented by Li_{1.07+b}Ti_{1.86}O₄ (0≤b≤1), and a lithium titanium-containing composite oxide containing at least one element selected from the group consisting of Nb, Mo, W, P, V, Sn, Cu, Ni, and Fe.

Examples of the lithium titanium-containing oxide include a lithium titanium-containing composite oxide represented by Li₂₊ₐA_{d}Ti_{6-b}B_{b}O_{14-c} (wherein A is one or more elements selected from Na, K, Mg, Ca, and Sr, B is a metal element other than Ti, 0≤a≤5, 0≤b≤6, 0≤c≤0.6, and 0≤d≤3). Li₂₊ₐA_{d}Ti_{6-b}B_{b}O_{14-c} has a crystal structure of a space group Cmca.

Other examples of the lithium titanium-containing oxide include an orthorhombic titanium-containing oxide. Examples of the orthorhombic titanium-containing oxide include a compound represented by Li₂₊ₐM^{I}_{2-b}Ti_{6-c}M^{II}_{d}O_{14+σ}. Here, M^{I} is at least one selected from the group consisting of Sr, Ba, Ca, Mg, Na, Cs, Rb and K. M^{II} is at least one selected from the group consisting of Zr, Sn, V, Nb, Ta, Mo, W, Y, Fe, Co, Cr, Mn, Ni and Al. The respective subscripts in the composition formula are as follows: 0≤a≤6, 0≤b≤2, 0≤c≤6, 0≤d≤6, and −0.5≤σ≤0.5. A specific example of the orthorhombic titanium-containing composite oxide is Li₂₊ₐNa₂Ti₆O₁₄ (0≤a≤6).

Examples of the titanium oxide include a titanium oxide represented by the general formula LiₐTiO₂ (0≤a≤2). In this case, the composition formula before charging is TiO₂. Examples of the titanium oxide include a titanium oxide having a monoclinic structure (bronze structure (B)), a titanium oxide having a rutile structure, and a titanium oxide having an anatase structure. TiO₂ (B) having a monoclinic structure (bronze structure (B)) is preferable. In addition, low crystalline TiO₂ (B) having a heat treatment temperature of 300 to 600° C. is also preferable.

Examples of the niobium-containing oxide include niobium oxides, niobium titanium-containing oxides, niobium tungsten-containing oxides, and niobium titanium molybdenum-containing oxides.

Examples of the niobium oxide include Nb₂O₅.

Examples of the niobium titanium-containing oxide include a monoclinic niobium titanium-containing oxide, Ti₂Nb₂O₉, Ti₂Nb₁₀O₂₉, TiNb₁₄O₃₇, TiNb₂₄O₆₂, and a substituted niobium titanium composite oxide in which at least a part of Nb and/or Ti is substituted with a different element. Examples of substitution elements are Na, K, Ca, Co, Ni, Si, P, V, Cr, Mo, Ta, Zr, Mn, Fe, Mg, B, Pb and Al. The substituted niobium-titanium composite oxide may contain one substitution element, or may contain two or more substitution elements.

Examples of the monoclinic niobium titanium-containing oxide include those represented by the general formula Li_{c}TiNb_{d}O₇(0≤c≤5 and 1≤d≤4). A more preferable composition is TiNb₂O₇.

An example of the monoclinic niobium titanium-containing oxide is a compound represented by LiₓTi_{1-y}M1_{y}Nb_{2-z} M2_{z}O_{7+δ}. Here, M1 is at least one selected from the group consisting of Zr, Si, and Sn. M2 is at least one selected from the group consisting of V, Ta, and Bi. The respective subscripts in the composition formula are as follows: 0≤x≤5, 0≤y<1, 0≤z<2, and −0.3≤δ≤0.3.

Another example of the monoclinic niobium titanium-containing oxide is a compound represented by Ti_{1-y} M3_{y+z}Nb_{2-z}O_{7-δ}. Here, M3 is at least one selected from Mg, Fe, Ni, Co, W, Ta, and Mo. The respective subscripts in the composition formula are as follows: 0≤y<1, 0≤z<2, and −0.3≤δ≤0.3.

Examples of the niobium tungsten-containing oxide include Nb₁₄W₃O₄₄, Nb₁₆W₅O₅₅, and Nb₁₈W₈O₆₉.

Examples of the niobium titanium molybdenum-containing oxide include a tetragonal titanium-niobium-molybdenum composite oxide represented by the general formula LiₐTi_{b}Nb_{2-2d}Mo_{c+2d}O_{2b+5+3c} (the subscripts a, b, c, and d are preferably within the ranges of 0≤a≤b+4+3c, 0.3≤b≤1.6, 0.3≤c≤1.6, and 0≤d≤0.4, respectively) and a composite oxide represented by the general formula LiₐM_{b}NbMo_{c}O_{d}, in which M is any one or more selected from the group consisting of Ti, V, Ta, Fe, Co, Mn, Ni, Bi, Sb, As, P, Cr, W, B, Na, K, Mg, Al, Ca, Y, and Si, and 0≤a≤b+2+3c, 0≤b≤1.4, 0≤c≤0.5, and 2.33 d/(1+b+c)≤2.50.

The negative electrode active material containing at least one of Li_{4/3+a}Ti_{5/3}O₄ (0≤a≤2) or Li_{c}TiNb_{d}O₇(0≤c≤5 and 1≤d≤4) can allow lithium ions to be rapidly inserted in and to be rapidly extracted from the active material, and is electrochemically and chemically stable against the nonaqueous electrolyte, and thus is excellent in high current discharge performance, rapid charge performance, and cycle life performance. In addition, the negative electrode active material is stable against the first solvent and the second solvent even at a high temperature, and thus is excellent in durable life performance.

The negative electrode active material particles may be in the form of primary particles or secondary particles in which primary particles are aggregated. Further, primary particles and secondary particles may be mixed.

An average particle size of the primary particles of the negative electrode active material is preferably in the range of 0.05 to 1 μm. This can improve the high current performance. Good performance can be obtained regardless of whether the particle shape is a granular form or a fibrous form. In a case where the negative electrode active material forms secondary particles, an average particle size of the secondary particles is preferably 2 to 20 μm. This can increase the electrode density and can also improve the cycle life performance.

The negative electrode active material desirably has an average particle size of 2 μm or less and a specific surface area by the BET method using N₂ adsorption of 2 to 50 m²/g. Thus, the affinity and electrochemical stability of the negative electrode with/against the nonaqueous electrolyte can be further increased.

A porosity of the negative electrode (excluding the current collector) is desirably in the range of 20 to 50%. This makes it possible to obtain a high-density negative electrode having excellent affinity between the negative electrode and the nonaqueous electrolyte. A more preferable range of the porosity is 25 to 40%.

The negative electrode current collector is differed depending on the type of the negative electrode active material. In a case where a lithium alloy or a carbon material is used as the negative electrode active material, a copper foil can be used as the negative electrode current collector. When a metal oxide that allows lithium ions to be inserted in and to be extracted from at a potential of 0.5 to 3.0 V (vs. Li/Li⁺) is used in the negative electrode active material, the negative electrode current collector can contain at least one of aluminum or an aluminum alloy. A more preferable negative electrode current collector is an aluminum foil or an aluminum alloy foil. The purity of the aluminum foil is preferably 99.99% or more. The aluminum alloy is preferably an alloy containing an element such as magnesium, zinc or silicon. On the other hand, a content of transition metals such as iron, copper, nickel or chromium is preferably 100 ppm or less.

The thickness of the negative electrode current collector is 20 μm or less, and is more preferably 15 μm or less.

The negative electrode active material-containing layer can contain a conductive agent. Examples of the conductive agent include carbon nanotubes, acetylene black, carbon black, coke (desirably having a heat treatment temperature of 800° C. to 2000° C. and an average particle size of 10 μm or less), carbon fibers, graphite, powders of metal compounds such as TiO, TiC and TiN, and powders of metals such as Al, Ni, Cu and Fe. The type of the conductive agent may be one or two or more. The use of carbon fibers having a fiber diameter of 1 μm or less reduces the electrode resistance and improves the cycle life performance.

The negative electrode active material-containing layer can contain a binder. Examples of the binder include polytetrafluoroethylene (PTFE), polyvinylidene fluoride (PVdF), fluorine rubber, acrylic rubber, styrene butadiene rubber, core shell binder, polyimide, and cellulose nanofibers. The type of the binder may be one or two or more.

The blending ratio of the negative electrode active material, the conductive agent and the binder is preferably 80 to 95% by weight for the negative electrode active material, 1 to 18% by weight for the conductive agent, and 2 to 7% by weight for the binder.

The negative electrode is produced, for example, by suspending a negative electrode active material, a conductive agent and a binder in an appropriate solvent, applying the suspension to a current collector, drying it, and pressing (for example, heat-pressing) it.

### (Positive Electrode)

The positive electrode includes a positive electrode current collector and a positive electrode active material-containing layer that is carried on or is in contact with one surface (one main surface) or both surfaces of the current collector and contains a positive electrode active material. The positive electrode active material-containing layer may contain either a binder or a conductive agent, or both of them.

Examples of the positive electrode active material include LiₓM_{y}O₂ (0<x≤1, 0<y≤1, and M is, for example, Mn), LiₓM_{2y}O₄ (0<x≤1, 0<y≤1, and M is, for example, Mn), lithium phosphorus oxide having an olivine structure (for example, LiₓM_{y}PO₄ (M is at least one element selected from Mn, Ni, Co, and Fe, 0<x≤1.1, and 0.8≤y≤1.1), LiₓFePO₄ (0<x≤1.1), LiₓFe_{1-y}Mn_{y}PO₄ (0<x≤1.1 and 0≤y≤1), and LiₓCoPO₄ (0<x≤1.1), LiₓMnPO₄ (0<x≤1.1)), lithium nickel cobalt composite oxides (for example, LiₓNi₁₋ₐCoₐO₂; 0<x≤1 and 0<a≤1), lithium cobalt composite oxides (for example, LiₓCoO₂; 0<x≤1), lithium nickel manganese cobalt composite oxides (for example, LiₓNi_{1-a-b}MnₐCo_{b}O₂; 0<x≤1, 0<1−a−b<1, 0<a≤1, and 0<b<1), lithium manganese cobalt composite oxides (for example, LiₓMn₁₋ₐCoₐO₂; 0<x≤1 and 0<a<1), spinel type lithium manganese nickel composite oxides (for example, LiₓMn₂₋ₐNiₐO₄; 0<x≤1 and 0<a<2), and fluorinated iron sulfates having a tavorite structure (for example, LiₓM_{y}SO₄F (0<x≤1, 0<y≤1, and M is at least one of Fe or Mn) and LiₓFe₁₋ₐMnₐSO₄F (0<x≤1 and 0<a≤1). The type of the positive electrode active material may be one or two or more.

The positive electrode active material can obtain a high voltage of 4 V or more. The lithium nickel manganese cobalt composite oxide can obtain a high voltage of 4 V or more, and can increase the energy density of the positive electrode.

The positive electrode containing at least one of a lithium cobalt composite oxide, a lithium nickel manganese cobalt composite oxide, a lithium manganese composite oxide, or a lithium phosphorus oxide having an olivine structure can improve the low-temperature output performance and the high-temperature life performance of the secondary battery. This is because the growth of the film formed at the surface of the positive electrode is suppressed, and the resistance of the positive electrode is reduced. In addition, since the stability in a high-temperature environment is increased, the storage performance can be improved. A more preferable positive electrode active material is a positive electrode active material including at least one of LiₓCoO₂, LixNi_{1-a-b}MnₐCo_{b}O₂, LiₓM_{2y}O₄ (0<x≤1, 0<y≤1, and M includes Mn), and LiₓFe_{1-y}Mn_{y}PO₄.

The positive electrode active material particles may be in the form of primary particles or secondary particles in which primary particles are aggregated. Further, primary particles and secondary particles may be mixed.

At least one element selected from Mg, Al, Ti, Nb, Sn, Zr, Ba, B, N, and C exist on the surfaces of the particles of the positive electrode active material. This makes it possible to suppress an oxidative decomposition reaction of the nonaqueous electrolyte in a high-temperature environment, and thus to suppress an increase in resistance. Therefore, the high-temperature life performance can be improved.

Each of Mg, Al, Ti, Nb, Sn, Zr, Ba, B, and N elements may be attached to the surfaces of the positive electrode active material particles in the form of metal oxide particles, phosphorus oxide particles, or nitride particles having a particle size of 0.001 to 1 μm, but the surface thereof may be coated with a metal oxide layer, a phosphorus oxide layer, a nitride layer, or a fluoride layer. Alternatively, a solid solution may be formed in the vicinity of the surfaces of the positive electrode active material particles. Examples of the metal oxide include MgO, Al₂O₃, SnO, ZrO₂, TiO₂, BaO, and B₂O₃. Examples of the phosphorus oxide include AlPO₄, Mg₃(PO₄)₂, and Sn₃(PO₄)₂. Examples of the nitride include metal nitrides such as Li₃N. Examples of the fluoride include metal fluorides such as LiF. In addition, as C, carbon particles having an average particle size of 1 μm or less are preferably attached to the particle surface of the active material. The amount of the compound containing at least one element selected from the group consisting of Mg, Al, Ti, Nb, Sn, Zr, Ba, B, N, and C is preferably 0.001 to 3% by weight of the positive electrode active material. By setting the amount within this range, a reaction between the positive electrode and the nonaqueous electrolyte in a high-temperature environment can be suppressed, and an increase in interface resistance between the positive electrode and the nonaqueous electrolyte can be suppressed. Therefore, it is possible to improve the output performance and the life performance of the secondary battery.

A film or layer containing at least one of a fluoride or a nitrogen-containing substance may be formed at at least a part of the surface of the positive electrode active material-containing layer. As a result, the oxidative decomposition of the nonaqueous electrolyte can be suppressed, so that gas generation at a high temperature can be suppressed. Examples of the fluoride include LiF. Examples of the nitrogen-containing substance include Li₃N. The film (layer) having the above composition can be formed of, for example, a nonaqueous electrolyte containing 0.5 to 10% by weight of LiNO₃.

The positive electrode current collector may contain at least one of aluminum or an aluminum alloy. As the positive electrode current collector, for example, an aluminum foil or an aluminum alloy foil is used.

A nitrogen-containing substance may be present at at least a part of the surface of the positive electrode current collector. This is because corrosion of the positive electrode current collector can be suppressed if the positive electrode operating voltage becomes a high voltage of 4 V or more at a high temperature. Since the corrosion is suppressed, the charge-and-discharge cycle smoothly proceeds, so that the life performance can be improved. Examples of the nitrogen-containing substance can include a nitric acid compound and a metal nitride such as Li₃N. Details of the nitrogen-containing substance are as described for the nonaqueous electrolyte.

The nitrogen-containing substance is desirably present at at least a part of the surface of the positive electrode current collector in contact with the positive electrode active material-containing layer. Accordingly, a corrosion suppressing effect can be enhanced.

An example of a second method for forming the nitrogen-containing substance will be described below. Lithium nitrate (LiNO₃) is added to a nonaqueous electrolyte in an amount of 0.1 to 10% by weight, a secondary battery including the nonaqueous electrolyte, a positive electrode, and a negative electrode is assembled, and then a battery charged to a positive electrode potential of 4 V (vs. Li/Li⁺) or more is aged at a temperature of 45 to 80° C., so that a part or the whole of the surface of the positive electrode current collector can be covered with the nitrogen-containing substance. Alternatively, after the concentration of LiFSI of a nonaqueous electrolyte is set to 1.5 M or more, and a secondary battery including the nonaqueous electrolyte, a positive electrode, and a negative electrode is assembled, a battery charged to a positive electrode potential of 4 V (vs. Li/Li⁺) or more may be aged at a temperature of 45 to 80° C. In this case, in addition to a part or the whole of the surface of the positive electrode current collector being covered with the nitrogen-containing substance, a fluoride can also be present at the surface of the positive electrode current collector. Lithium nitrate can form a nitrogen-containing substance at the surface of the positive electrode current collector while the ion conductivity of the nonaqueous electrolyte is maintained in a practical range without increase in viscosity of the nonaqueous electrolyte.

The positive electrode and the negative electrode used in assembling the secondary battery can be produced, for example, by the following method. The positive electrode is produced, for example, by suspending a positive electrode active material, a conductive agent and a binder in a suitable solvent, applying the suspension to a positive electrode current collector, and drying and pressing it. On the other hand, the negative electrode is produced, for example, by suspending a negative electrode active material, a conductive agent and a binder in an appropriate solvent, applying the suspension to a current collector, drying it, and pressing it.

A substance containing at least one element (atom) selected from the group consisting of N, B, and F is desirably present at at least a part of the surface of the positive electrode current collector. Examples of the form that the substance may take include a film-like form and a layered form. The substance may be a compound containing at least one element (atom) selected from the group consisting of N, B, and F. A B-containing substance has excellent stability. Therefore, in a case where the positive electrode current collector contains at least one of aluminum or an aluminum alloy, it is possible to enhance the effect of suppressing corrosion of the positive electrode current collector if the positive electrode operating voltage becomes a high voltage of 4 V or more at a high temperature. Also, in a case where the positive electrode current collector contains at least one of aluminum or an aluminum alloy, F can form a fluoride with Al, so that an F-containing substance can be stably present at the surface of the positive electrode current collector. As a result, it is possible to enhance the effect of suppressing corrosion of the positive electrode current collector.

Examples of the third method for forming a substance containing at least one element (atom) selected from the group consisting of N, B, and F at at least a part of the surface of the positive electrode current collector can include a method similar to the above-described first method for forming a film-like substance or a layered substance at at least one of the positive electrode or the negative electrode. Also, the method for forming an N-containing substance may be a method similar to the second method for forming the nitrogen-containing substance.

The thickness of the positive electrode current collector can be 20 μm or less. A more preferable range is 15 μm or less.

The positive electrode active material-containing layer may contain a conductive agent. Examples of the conductive agent can include acetylene black, carbon black, and graphite. The type of the conductive agent may be one or two or more.

The positive electrode active material-containing layer may contain a binder. Examples of the binder include polytetrafluoroethylene (PTFE), polyvinylidene fluoride (PVdF), fluorine rubber, and acrylic materials. The type of the binder may be one or two or more.

The blending ratio of the positive electrode active material, the conductive agent and the binder is preferably 80 to 95% by weight for the positive electrode active material, 3 to 19% by weight for the conductive agent, and 1 to 7% by weight for the binder.

The specific surface area of the positive electrode active material-containing layer by the BET method is preferably in the range of 0.1 to 2 m²/g.

The positive electrode active material-containing layer may be porous.

The positive electrode is produced, for example, by suspending a positive electrode active material, a conductive agent and a binder in a suitable solvent, applying the suspension to a positive electrode current collector, and drying and pressing it.

The secondary battery of the embodiment may include a separator and a container member in addition to the nonaqueous electrolyte, the negative electrode, and the positive electrode. The negative electrode, the positive electrode, and the separator may configure an electrode group. The nonaqueous electrolyte may be held in the electrode group. The form of the electrode group is not particularly limited, and can be, for example, a stacked type, a wound type, or the like.

### (Separator)

The separator is disposed between the positive electrode and the negative electrode. A part of the separator may be opposed to or in contact with only the positive electrode or only the negative electrode.

Examples of the separator include synthetic resin nonwoven fabrics, polyethylene porous films, polypropylene porous films, and cellulose nonwoven fabrics.

At least a part of a surface of the separator may be covered with a layer containing inorganic particles such as alumina.

### (Container Member)

At least the positive electrode, the negative electrode, and the nonaqueous electrolyte are housed in the container member. The positive electrode and the negative electrode may be housed in the container member in the form of an electrode group with the separator or the like disposed therebetween.

As the container member, a metal container or a laminated film container can be used.

As the metal container, a metal can made of aluminum, an aluminum alloy, iron, stainless steel or the like and having a rectangular or cylindrical shape can be used. The metal container may include a lid. The plate thickness of the container is desirably 0.5 mm or less, more preferably 0.3 mm or less.

Examples of the laminated film include a multilayer film in which an aluminum foil is covered with a resin film. As the resin, polymers such as polypropylene (PP), polyethylene (PE), nylon or polyethylene terephthalate (PET) can be used. The thickness of the laminated film is preferably 0.2 mm or less. The purity of the aluminum foil is preferably 99.5% or more.

The metal can made of an aluminum alloy is preferably made of an alloy containing elements such as manganese, magnesium, zinc or silicon and having an aluminum purity of 99.8% or less. The strength of the metal can made of an aluminum alloy is dramatically increased, so that the thickness of the can be reduced. As a result, it is possible to realize a thin battery that is lightweight, has high output, and has excellent heat dissipation.

Next, a method for measuring the nitrogen-containing substance and the like will be described.

First, a method of taking out the electrode (positive electrode or negative electrode) from the battery will be described.

The secondary battery is disassembled in an argon atmosphere, and the positive electrode current collector, the positive electrode, or the negative electrode to be measured is taken out. The object to be measured is washed with a solvent including dimethyl carbonate in an argon atmosphere, dried under vacuum at 100° C., and then measured by the method which will be described below.

### <Method for Confirming Nitrogen-Containing Substance>

Whether or not the nitrogen-containing compound is present at the surface of the positive electrode current collector or the positive electrode active material-containing layer can be confirmed by X-ray photoelectron spectroscopy (XPS) under the conditions which will be described below.

As an XPS apparatus, Quantera SXM manufactured by ULVAC-PHI, Inc. or an apparatus having a function equivalent thereto can be used. As an excitation X-ray source, a single-crystal spectroscopic Al-Kα ray (1486.6 eV) is used. An X-ray output is 4 kW (13 kV×310 mA), a photoelectron detection angle is 45°, and an analysis area is about 4 mm×0.2 mm. Scanning is performed at 0.10 eV/step.

For example, the presence of Li₃N can be confirmed by detecting a spectrum derived from a Li—N bond (399 eV) by state analysis of a surface (Nis) of a positive electrode current collector (for example, an aluminum foil). On the other hand, the presence of a nitric acid compound can be confirmed by detecting a spectrum derived from the NO₃⁻ bond (407 eV) by state analysis of a surface (Nis) of a positive electrode current collector (for example, aluminum foil).

Whether or not each of the fluorine-containing substance and the boron-containing substance is present at the surface of the positive electrode current collector can be confirmed by the method that will be described below.

### <Method for Confirming Fluorine-Containing Substance>

By using an experimental method and a measuring device similar to those used in the method for confirming the nitrogen-containing substance, LiF derived from a Li—F bond (685.01 eV) of an XPS pattern of F1s or AlF₃ derived from an Al—F bond (686.3 eV) of an XPS pattern of F1s, for example, can be confirmed as a fluorine-containing substance by state analysis of the positive electrode current collector.

### <Method for Confirming Boron-Containing Substance>

By using an experimental method and a measuring device similar to those used in the method for confirming the nitrogen-containing substance, AlBO₃ or B₂O₃ derived from a B—O bond (193.1 eV) of an XPS pattern of B1s, for example, can be confirmed as a boron-containing substance by state analysis of the positive electrode current collector.

### <Measurement of Average Particle Size of Active Material Particle>

The average particle size of the active material particles is measured using a laser diffraction type grain size distribution measuring device (Shimadzu SALD-300 manufactured by Shimadzu Corporation or a device having a function equivalent thereto). About 0.1 g of a sample, a surfactant, and 1 to 2 mL of distilled water are added to a beaker, and the mixture is sufficiently stirred. Then, the mixture is injected into a stirring water tank, luminous intensity distribution is measured 64 times at intervals of 2 seconds, and an average particle size determined from the obtained grain size distribution data is obtained.

### <Measurement of BET Specific Surface Areas of Active Material and Electrode Using N₂ Adsorption>

In a case of measuring the BET specific surface area of the active material using N₂ adsorption, 1 g of an active material powder is prepared as a sample. In a case of measuring the BET specific surface area of the electrode using N₂ adsorption, two sheets obtained by cutting the electrode into a size of 2×2 cm² are used as samples. A BET specific surface area measuring device manufactured by Yuasa Ionics Inc. is used, and nitrogen gas is used as an adsorption gas.

### <Method for Measuring Porosity of Negative Electrode>

The porosity of the negative electrode is calculated by comparing the volume of the negative electrode active material-containing layer with the volume of the negative electrode active material-containing layer when the porosity is 0%, and considering an increase from the volume of the negative electrode active material-containing layer when the porosity is 0% as a pore volume. In a case where the negative electrode active material-containing layer is formed on both surfaces of the current collector, the volume of the negative electrode active material-containing layer is a sum of the volumes of the negative electrode active material-containing layers on both surfaces.

### <Positive Electrode Active Material>

The crystal structure and elemental composition of the positive electrode active material can be confirmed by powder X-ray diffraction (XRD) measurement and inductively coupled plasma (ICP) emission spectroscopy.

### <Negative Electrode Active Material>

The crystal structure and elemental composition of the negative electrode active material can be confirmed by powder X-ray diffraction (XRD) measurement and inductively coupled plasma (ICP) emission spectroscopy.

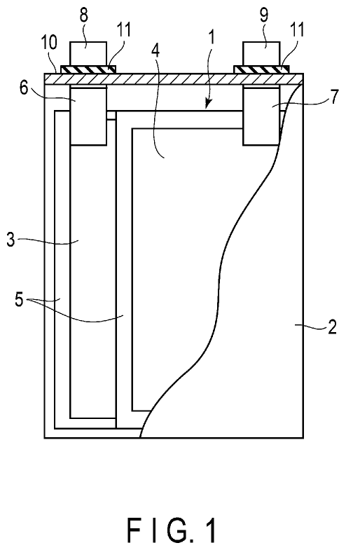

An example of the secondary battery according to the embodiment will be described with reference to FIGS. 1, 2, 3, and 4.

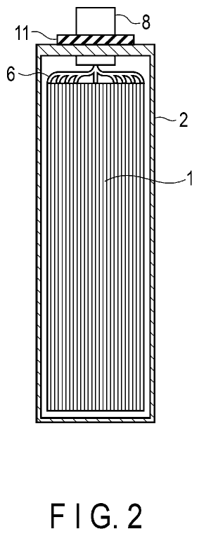

FIGS. 1 and 2 show an example of the secondary battery using a metal container.

An electrode group 1 is stored in a rectangular tubular metal container 2. The electrode group 1 has a structure formed by spirally winding the positive electrode active material-containing layer of a positive electrode 3 and the negative electrode active material-containing layer of a negative electrode 4 with a separator 5 interposing therebetween so as to form a flat shape. The separator 5 covers the surface (principal surface) of the positive electrode active material-containing layer or negative electrode active material-containing layer. As shown in FIG. 2, a strip-shaped positive electrode lead 6 is electrically connected to each of a plurality of portions at an end of the positive electrode 3 located on an end face of the electrode group 1. A strip-shaped negative electrode lead 7 is electrically connected to each of a plurality of portions at an end of the negative electrode 4 located on the end face. The plurality of positive electrode leads 6 are bundled, and in this state, electrically connected to a positive electrode tab 8. A positive electrode terminal is formed from the positive electrode leads 6 and the positive electrode tab 8. In addition, the negative electrode leads 7 are bundled, and in this state, electrically connected to a negative electrode tab 9. A negative electrode terminal is formed from the negative electrode leads 7 and the negative electrode tab 9. A sealing plate 10 made of a metal is fixed to the opening portion of the metal container 2 by welding or the like. The positive electrode tab 8 and the negative electrode tab 9 are extracted to the outside from outlet holes formed in the sealing plate 10, respectively. The inner circumference surface of each outlet hole of the sealing plate 10 is covered with an insulating member 11 to avoid a short circuit caused by contact between the positive electrode tab 8 and the negative electrode tab 9.

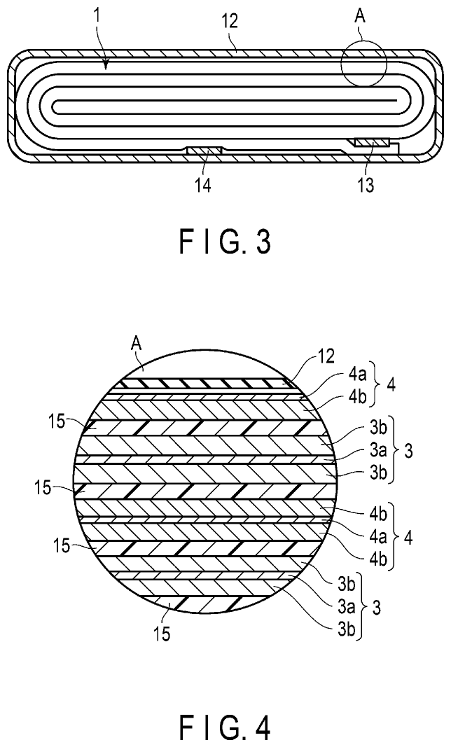

FIGS. 3 and 4 show an example of a secondary battery using a container member made of a laminated film.

As shown in FIGS. 3 and 4, the flat wound electrode group 1 is stored in a sack-shaped container 12 made of a laminated film including a metal layer interposing between two resin films. The flat wound electrode group 1 is formed by spirally winding a stacked structure obtained by stacking the negative electrode 4, a separator 15, the positive electrode 3, and the separator 15 from the outside, and pressing the wound structure. The outermost negative electrode 4 has an arrangement in which a negative electrode active material-containing layer 4b containing a negative electrode active material on one surface on the inner side of a negative electrode current collector 4a, as shown in FIG. 4, and the remaining negative electrodes 4 are arranged by forming the negative electrode active material-containing layers 4b on both surfaces of the negative electrode current collector 4a. The positive electrode 3 is arranged by forming positive electrode active material-containing layers 3b on both surfaces of a positive electrode current collector 3a.

Near the outer end of the wound electrode group 1, a negative electrode terminal 13 is electrically connected to the negative electrode current collector 4a of the outermost negative electrode 4, and a positive electrode terminal 14 is electrically connected to the positive electrode current collector 3a of the positive electrode 3 on the inner side. The negative electrode terminal 13 and the positive electrode terminal 14 extend outward from the opening portion of the sack-shaped container 12. The opening portion of the sack-shaped container 12 is heat-sealed, thereby sealing the wound electrode group 1. At the time of heat-sealing, the negative electrode terminal 13 and the positive electrode terminal 14 are sandwiched by the sack-shaped container 12 in the opening portion.

The secondary battery of the embodiment described above contains a nonaqueous electrolyte containing a nonaqueous solvent containing a first solvent including at least one selected from the group consisting of EP, PP, and EB and a second solvent including GBL, and an electrolyte containing LiFSI, and thus can realize a secondary battery that can suppress corrosion of the positive electrode current collector and is excellent in high current performance, low-temperature performance, and high-temperature life performance.

### Second Embodiment

A battery module of the second embodiment includes a plurality of the secondary batteries according to the embodiment.

Examples of the battery module include those including a plurality of single batteries electrically connected in series and/or in parallel as a constituent unit, and those including a first unit including a plurality of single batteries electrically connected in series or a second unit including a plurality of single batteries electrically connected in parallel. The battery module may include at least one of these configurations.

Examples of the form in which a plurality of secondary batteries are electrically connected in series and/or in parallel include those in which a plurality of batteries each having a container member are electrically connected in series and/or in parallel, and those in which a plurality of electrode groups or bipolar type electrode bodies housed in a common housing are electrically connected in series and/or in parallel. In a specific example of the former, the positive electrode terminals and the negative electrode terminals of a plurality of secondary batteries are connected by a metal bus bar (e.g., aluminum, nickel, copper). In a specific example of the latter, a plurality of electrode groups or bipolar type electrode bodies are housed in a single housing in a state of being electrochemically insulated by partition walls, and are electrically connected in series. In the case of secondary batteries, the number of batteries to be electrically connected in series is set within the range of 5 to 7, so that the voltage compatibility with lead storage batteries is improved. In order to improve the voltage compatibility with the lead storage batteries, it is preferable to connect five or six single batteries in series.

A metal can made of an aluminum alloy, iron, stainless steel or the like, a plastic container, or the like can be used for the housing that houses the battery module. Further, the plate thickness of the container is desirably 0.5 mm or more.

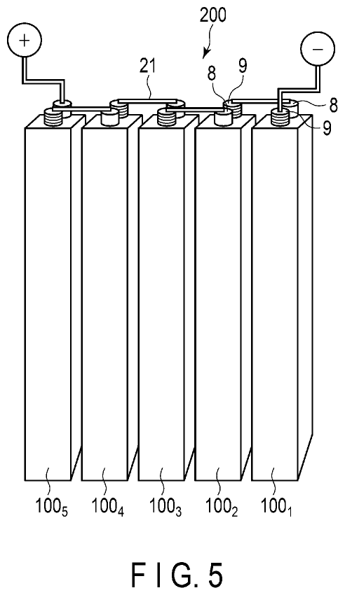

An example of a battery module will be described with reference to FIG. 5. A battery module 200 shown in FIG. 5 includes, as single batteries, a plurality of rectangular secondary batteries 100₁ to 100₅ shown in FIG. 1. A positive electrode tab 8 of the battery 100₁ and a negative electrode tab 9 of the battery 100₂ located adjacent to the battery 100₁ are electrically connected by a lead or bus bar 21. In addition, a positive electrode tab 8 of the battery 100₂ and a negative electrode tab 9 of the battery 100₃ located adjacent to the battery 100₂ are electrically connected by a lead or bus bar 21. The batteries 100₁ to 100₅ are thus electrically connected in series.

The battery module according to the embodiment described above includes the secondary battery of the embodiment, and thus can realize a battery module excellent in high current performance, low-temperature performance, and high-temperature life performance.

### Third Embodiment

A battery pack according to the third embodiment can include one or more secondary batteries (single batteries) according to the embodiment. A plurality of secondary batteries may be electrically connected in series, in parallel, or in a combination of series and parallel to constitute a battery module. The battery pack according to the embodiment may include a plurality of battery modules.

The battery pack according to the embodiment may further include a protective circuit. The protective circuit has a function of controlling charge/discharge of the secondary battery. Alternatively, a circuit included in a device that uses the battery pack as a power source (for example, an electronic device, an automobile, etc.) can be used as the protective circuit for the battery pack.

Moreover, the battery pack according to the embodiment may further include an external power distribution terminal. The external power distribution terminal is configured to externally output current from the secondary battery, and to input current into the secondary battery. In other words, when the battery pack is used as a power source, the current is provided out via the external power distribution terminal. When the battery pack is charged, the charging current (including regenerative energy of motive force of vehicles such as automobiles) is provided to the battery pack via the external power distribution terminal.

Next, an example of a battery pack according to the embodiment will be described with reference to the drawings.

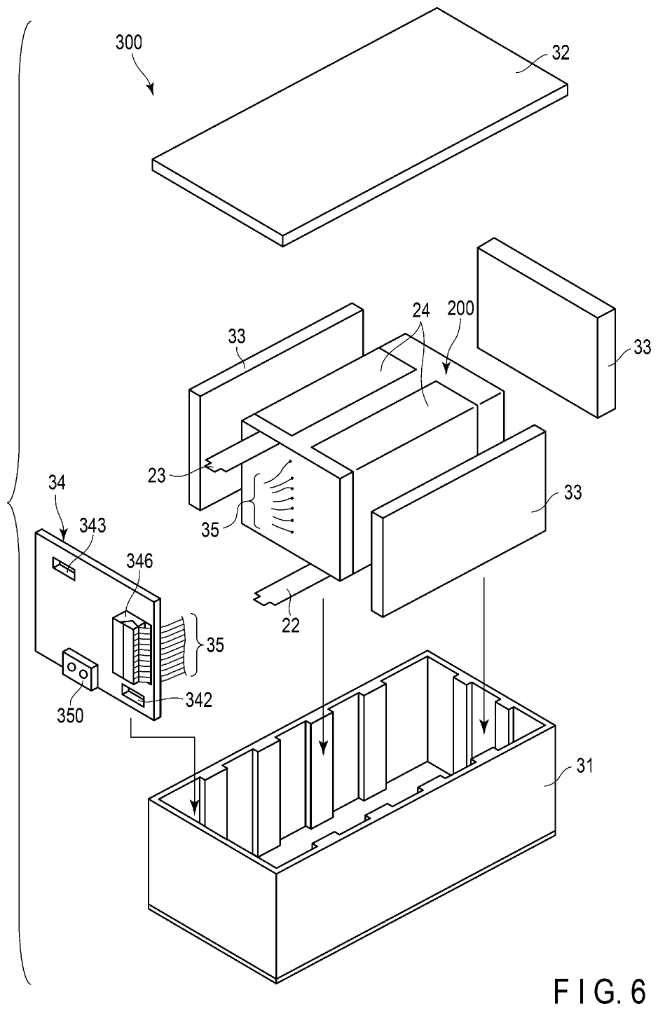

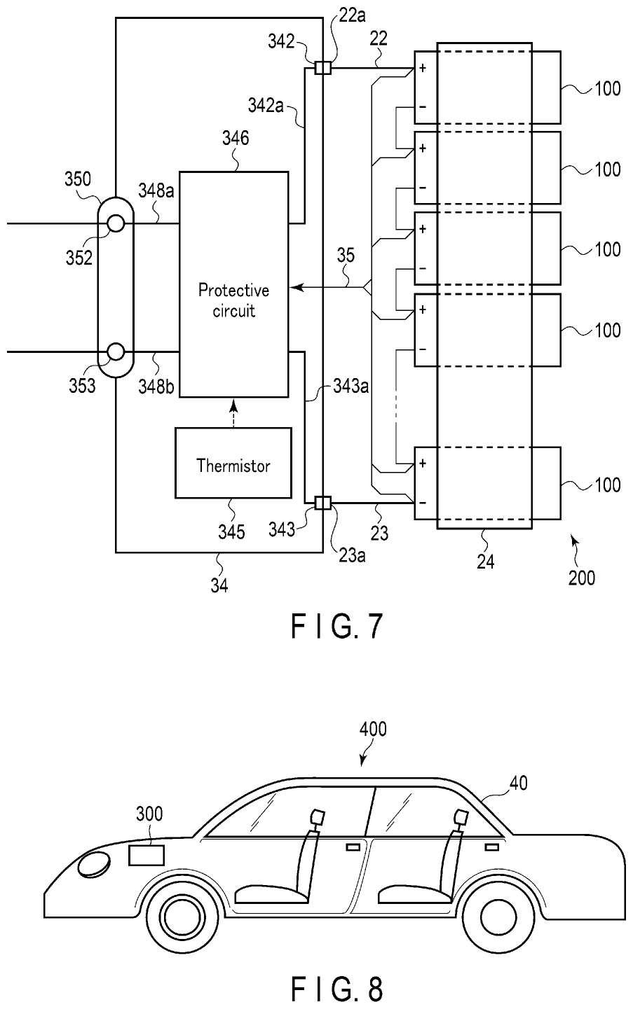

FIG. 6 is an exploded perspective view schematically showing an example of the battery pack according to the embodiment. FIG. 7 is a block diagram showing an example of an electric circuit of the battery pack shown in FIG. 6.

A battery pack 300 shown in FIGS. 6 and 7 includes a housing container 31, a lid 32, protective sheets 33, a battery module 200, a printed wiring board 34, wires 35, and an insulating plate (not shown).

The housing container 31 shown in FIG. 6 is a square-bottomed container having a rectangular bottom surface. The housing container 31 is configured to be capable of housing the protective sheets 33, the battery module 200, the printed wiring board 34, and the wires 35. The lid 32 has a rectangular shape. The lid 32 covers the housing container 31 to house the battery module 200 and such. Although not illustrated, the housing container 31 and the lid 32 are provided with openings, connection terminals, or the like for connection to an external device or the like.

The battery module 200 includes plural single-batteries 100, a positive electrode-side lead 22, a negative electrode-side lead 23, and adhesive tape(s) 24.

At least one of the plural single-batteries 100 is a battery according to the first embodiment. The plural single-batteries 100 are electrically connected in series, as shown in FIG. 7. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape(s) 24 fastens the plural single-batteries 100. The plural single-batteries 100 may be fixed using a heat shrinkable tape in place of the adhesive tape(s) 24. In this case, protective sheets 33 are arranged on both side surfaces of the battery module 200, and the heat shrinkable tape is wound around the battery module 200 and protective sheets 33. After that, the heat shrinkable tape is shrunk by heating to bundle the plural single-batteries 100.

One end of the positive electrode-side lead 22 is connected to the battery module 200. The one end of the positive electrode-side lead 22 is electrically connected to the positive electrode(s) of one or more single-battery 100. One end of the negative electrode-side lead 23 is connected to the battery module 200. The one end of the negative electrode-side lead 23 is electrically connected to the negative electrode(s) of one or more single-battery 100.

The printed wiring board 34 is provided along one face in the short side direction among the inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side (positive-side) wiring 348a, and a minus-side (negative-side) wiring 348b. One principal surface of the printed wiring board 34 faces a side surface of the battery module 200. An insulating plate (not shown) is disposed in between the printed wiring board 34 and the battery module 200.

The other end 22a of the positive electrode-side lead 22 is electrically connected to the positive electrode-side connector 342. The other end 23a of the negative electrode-side lead 23 is electrically connected to the negative electrode-side connector 343.

The thermistor 345 is fixed to one principal surface of the printed wiring board 34. The thermistor 345 detects the temperature of each single-battery 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive-side terminal 352 and a negative-side terminal 353.

The protective circuit 346 is fixed to the other principal surface of the printed wiring board 34. The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the plural single-batteries 100 via the wires 35.

The protective sheets 33 are arranged on both inner surfaces of the housing container 31 along the long side direction and on the inner surface along the short side direction facing the printed wiring board 34 across the battery module 200. The protective sheets 33 are made of, for example, resin or rubber.

The protective circuit 346 controls charge and discharge of the plural single-batteries 100. The protective circuit 346 is also configured to cut-off electric connection between the protective circuit 346 and the external power distribution terminal 350 (positive-side terminal 352, negative-side terminal 353) to external device(s), based on detection signals transmitted from the thermistor 345 or detection signals transmitted from each single-battery 100 or the battery module 200.

An example of the detection signal transmitted from the thermistor 345 is a signal indicating that the temperature of the single-battery(s) 100 is detected to be a predetermined temperature or more. An example of the detection signal transmitted from each single-battery 100 or the battery module 200 include a signal indicating detection of over-charge, over-discharge, and overcurrent of the single-battery 100. When detecting over charge or the like for each of the single-batteries 100, the battery voltage may be detected, or a positive electrode potential or negative electrode potential may be detected. In the latter case, a lithium electrode to be used as a reference electrode may be inserted into each single-battery 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when using the battery pack 300 as a power source, the current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may not be needed. In this case, the positive electrode-side lead 22 and the negative electrode-side lead 23 may respectively be used as the positive-side terminal and negative-side terminal of the external power distribution terminal.

Such a battery pack is used, for example, in applications where excellent cycle performance is demanded when a large current is extracted. More specifically, the battery pack is used as, for example, a power source for electronic devices, a stationary battery, or an onboard battery for various kinds of vehicles and railway cars. An example of the electronic device is a digital camera. The battery pack is particularly favorably used as an onboard battery.

The battery pack according to the embodiment includes the secondary battery according to the embodiment or the battery module according to the embodiment. Therefore, a battery pack excellent in high current performance, low-temperature performance, and high-temperature life performance can be realized.

### Fourth Embodiment

According to a fourth embodiment, a vehicle is provided. This vehicle is mounted with the battery pack according to the embodiment.

In the vehicle according to the embodiment, the battery pack is intended, for example, for recovering regenerative energy of power of the vehicle. The vehicle may include a mechanism (for example, a regenerator) that converts kinetic energy of the vehicle into regenerative energy.

Examples of the vehicle according to the embodiment include two-wheel to four-wheel hybrid electric automobiles, two-wheel to four-wheel electric automobiles, assisted bicycles, and railway vehicles.

The mounting position of the battery pack in the vehicle according to the embodiment is not particularly limited. For example, when the battery pack is mounted in an automobile, the battery pack can be mounted in the engine room of the vehicle, in a rear part of the vehicle, or under the seat.

The vehicle according to the embodiment may be mounted with a plurality of battery packs. In this case, the batteries included in the respective battery packs may be electrically connected in series, may be electrically connected in parallel, or may be electrically connected in a combination of series and parallel. For example, when each of the battery packs includes a battery module, the battery modules may be electrically connected in series, may be electrically connected in parallel, or may be electrically connected in a combination of series and parallel. Alternatively, when each of the battery packs includes a single battery, the respective batteries may be electrically connected in series, may be electrically connected in parallel, or may be electrically connected in a combination of series and parallel.

An example of the vehicle according to the embodiment is explained below, with reference to the drawings.

FIG. 8 is a partially see-through diagram schematically showing an example of a vehicle according to the embodiment.

A vehicle 400, shown in FIG. 8 includes a vehicle body 40 and a battery pack 300 according to the third embodiment. In the example shown in FIG. 8, the vehicle 400 is a four-wheeled automobile.

This vehicle 400 may have plural battery packs 300 installed. In such a case, the batteries (e.g., single-batteries or battery module) included in the battery packs 300 may be connected in series, connected in parallel, or connected in a combination of in-series connection and in-parallel connection.

In FIG. 8, depicted is an example where the battery pack 300 is installed in an engine compartment located at the front of the vehicle body 40. As mentioned above, for example, the battery pack 300 may be alternatively installed in rear sections of the vehicle body 40, or under a seat. The battery pack 300 may be used as a power source of the vehicle 400. The battery pack 300 can also recover regenerative energy of motive force of the vehicle 400.

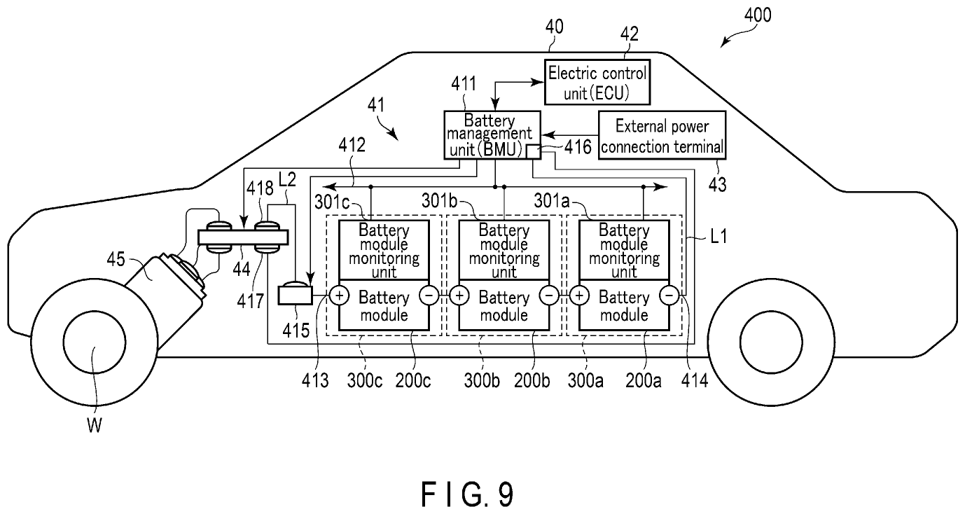

Next, with reference to FIG. 9, an aspect of operation of the vehicle according to the embodiment is explained.

FIG. 9 is a diagram schematically showing an example of a control system related to an electric system in the vehicle according to the embodiment. A vehicle 400, shown in FIG. 9, is an electric automobile.

The vehicle 400, shown in FIG. 9, includes a vehicle body 40, a vehicle power source 41, a vehicle ECU (electric control unit) 42, which is a master controller of the vehicle power source 41, an external terminal (an external power connection terminal) 43, an inverter 44, and a drive motor 45.

The vehicle 400 includes the vehicle power source 41, for example, in the engine compartment, in the rear sections of the automobile body, or under a seat. In FIG. 9, the position of the vehicle power source 41 installed in the vehicle 400 is schematically shown.

The vehicle power source 41 includes plural (for example, three) battery packs 300a, 300b and 300c, a battery management unit (BMU) 411, and a communication bus 412.

The battery pack 300a includes a battery module 200a and a battery module monitoring unit 301a (e.g., a VTM:voltage temperature monitoring). The battery pack 300b includes a battery module 200b and a battery module monitoring unit 301b. The battery pack 300c includes a battery module 200c and a battery module monitoring unit 301c. The battery packs 300a to 300c are battery packs similar to the aforementioned battery pack 300, and the battery modules 200a to 200c are battery modules similar to the aforementioned battery module 200. The battery modules 200a to 200c are electrically connected in series. The battery packs 300a, 300b and 300c can each be independently removed, and may be exchanged by a different battery pack 300.

Each of the battery modules 200a to 200c includes plural single-batteries connected in series. At least one of the plural single-batteries is the secondary battery according to the embodiment. The battery modules 200a to 200c each perform charging and discharging via a positive electrode terminal 413 and a negative electrode terminal 414.

The battery management unit 411 performs communication with the battery module monitoring units 301a to 301c and collects information such as voltages or temperatures for each of the single-batteries 100 included in the battery modules 200a to 200c included in the vehicle power source 41. In this manner, the battery management unit 411 collects information concerning security of the vehicle power source 41.

The battery management unit 411 and the battery module monitoring units 301a to 301c are connected via the communication bus 412. In communication bus 412, a set of communication lines is shared at multiple nodes (i.e., the battery management unit 411 and one or more battery module monitoring units 301a to 301c). The communication bus 412 is, for example, a communication bus configured based on CAN (Control Area Network) standard.

The battery module monitoring units 301a to 301c measure a voltage and a temperature of each single-battery in the battery modules 200a to 200c based on commands from the battery management unit 411. It is possible, however, to measure the temperatures only at several points per battery module, and the temperatures of all of the single-batteries need not be measured.

The vehicle power source 41 may also have an electromagnetic contactor (for example, a switch unit 415 shown in FIG. 9) for switching on and off electrical connection between the positive electrode terminal 413 and the negative electrode terminal 414. The switch unit 415 includes a precharge switch (not shown), which is turned on when the battery modules 200a to 200c are charged, and a main switch (not shown), which is turned on when output from the battery modules 200a to 200c is supplied to a load. The precharge switch and the main switch each include a relay circuit (not shown), which is switched on or off based on a signal provided to a coil disposed near the switch elements. The magnetic contactor such as the switch unit 415 is controlled based on control signals from the battery management unit 411 or the vehicle ECU 42, which controls the operation of the entire vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management unit 411 or the vehicle ECU 42, which controls the entire operation of the vehicle. Due to the inverter 44 being controlled, output voltage from the inverter 44 is adjusted.

The drive motor 45 is rotated by electric power supplied from the inverter 44. The drive generated by rotation of the motor 45 is transferred to an axle and driving wheels W via a differential gear unit, for example.

The vehicle 400 also includes a regenerative brake mechanism (i.e., a regenerator), though not shown. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connecting line Li is connected to the negative electrode terminal 414 of the vehicle power source 41. The other terminal of the connecting line Li is connected to a negative electrode input terminal 417 of the inverter 44. A current detector (current detecting circuit) 416 in the battery management unit 411 is provided on the connecting line Li in between the negative electrode terminal 414 and negative electrode input terminal 417.

One terminal of a connecting line L2 is connected to the positive electrode terminal 413 of the vehicle power source 41. The other terminal of the connecting line L2 is connected to a positive electrode input terminal 418 of the inverter 44. The switch unit 415 is provided on the connecting line L2 in between the positive electrode terminal 413 and the positive electrode input terminal 418.

The external terminal 43 is connected to the battery management unit 411. The external terminal 43 is able to connect, for example, to an external power source.

The vehicle ECU 42 performs cooperative control of the vehicle power source 41, switch unit 415, inverter 44, and the like, together with other management units and control units including the battery management unit 411 in response to inputs operated by a driver or the like. Through the cooperative control by the vehicle ECU 42 and the like, output of electric power from the vehicle power source 41, charging of the vehicle power source 41, and the like are controlled, thereby performing the management of the whole vehicle 400. Data concerning the security of the vehicle power source 41, such as a remaining capacity of the vehicle power source 41, are transferred between the battery management unit 411 and the vehicle ECU 42 via communication lines.

The vehicle according to the embodiment includes the battery pack according to the embodiment. Therefore, it is possible to realize a vehicle having excellent traveling performance in a wide temperature range from low temperature to high temperature.

### EXAMPLES

Hereinafter, examples of the present invention will be described in detail with reference to the drawings, but the present invention is not limited to the examples which will be described below.

### Example 1

As a positive electrode active material, lithium nickel cobalt manganese composite oxide (LiNi_{0.8}Co_{0.1}Mn_{0.1}O₂) particles having a layered structure and an average particle size of 3 μm were used. In the positive electrode active material, 8% by weight of graphite powder relative to the entire positive electrode active material-containing layer as a conductive agent and 5% by weight of PVdF relative to the entire positive electrode active material-containing layer as a binder were blended, and dispersed in an n-methylpyrrolidone (M4P) solvent to prepare a slurry. The slurry was applied to both surfaces of an aluminum alloy foil (purity: 99%) having a thickness of 15 μm, dried, and subjected to a pressing step to produce a positive electrode having an application amount of 12.8 mg/cm² on one surface, a thickness of a positive electrode active material-containing layer on one surface of 43 μm, and an electrode density of 3.0 g/cm³. The BET specific surface area of the positive electrode active material-containing layer was 0.5 m²/g.

In addition, a spinel type lithium titanate (Li₄Ti₅O₁₂) powder having an average particle size of 0.6 μm, a BET specific surface area of 8 m²/g, and a Li insertion potential of 1.55 V (vs. Li/Li⁺), a coke powder having an average particle size of 0.4 μm and a BET specific surface area of 50 m²/g, an acetylene black powder, and PVdF as a binder were blended at a weight ratio of 90:6:2:2 and dispersed in an n-methylpyrrolidone (M4P) solvent to prepare a slurry. The resulting slurry was applied to an aluminum alloy foil (purity: 99.3%) having a thickness of 15 μm, dried, and subjected to a pressing step to produce a negative electrode having an application amount of 13 mg/cm² on one surface, a thickness of a negative electrode active material-containing layer on one surface of 59 μm, and an electrode density of 2.2 g/cm³. The porosity of the negative electrode excluding the current collector was 35%. The BET specific surface area (surface area per g of the negative electrode active material-containing layer) of the negative electrode active material-containing layer was 10 m²/g.

A separator made of a polyethylene porous film having a thickness of 20 μm was superimposed and covered on the positive electrode. The positive electrode covered with the separator was superposed on the negative electrode, the positive electrode active material-containing layer was opposed to the negative electrode active material-containing layer with the separator interposed therebetween, and the electrodes were spirally wound to produce an electrode group. The electrode group was pressed and formed into a flat shape. This electrode group was housed in a container made of a thin metal can made of an aluminum alloy (Al purity: 99%) having a thickness of 0.25 mm.

As a nonaqueous electrolyte, as a first solvent EP and as a second solvent GBL were mixed so that the volume ratio between the first solvent and the second solvent was 7:3 (70% by volume: 30% by volume). In the resulting mixed nonaqueous solvent, 1.2 M (mol/L) of lithium bisfluorosulfonylimide (LiN(FSO₂)₂) was dissolved as an electrolyte. To this, 1% by weight of LiNO₃ and 1% by weight of PS were added as additives to prepare a liquid nonaqueous electrolyte (nonaqueous electrolytic solution). The nonaqueous electrolyte was injected into the electrode group in the container to produce a thin nonaqueous electrolyte secondary battery having the above-described structure shown in FIG. 1 and having a thickness of 4 mm, a width of 30 mm, and a height of 60 mm.

Before a charge-and-discharge test, the produced nonaqueous electrolyte battery was charged up to 3.0 V at 0.7 A in an environment of 60° C., and brought into a charged state such that the positive electrode potential was 4 V (vs. Li/Li⁺) or more. Thereafter, a high temperature aging treatment was performed at 60° C. for 24 hours to obtain a nonaqueous electrolyte secondary battery.

For the obtained secondary battery, the presence of Li₃N and a nitric acid compound at a part of the surface of the positive electrode current collector which faces the positive electrode active material-containing layer, was confirmed through surface analysis by the X-ray photoelectron spectroscopy (XPS) described above. In addition, the presence of Li₃N and a nitric acid compound at a part of the surface of the positive electrode active material-containing layer was confirmed through the same surface analysis. Li₃N was derived from Li—N bonds (399 eV). On the other hand, the nitric acid compound was derived from NO₃⁻ bonds (407 eV).

### Examples 2 to 22

A thin nonaqueous electrolyte battery was produced in the same manner as described in Example 1 except for the nonaqueous solvent composition, the electrolyte, the negative electrode active material, the positive electrode active material, and the additive shown in the following Tables 1 to 3. In the columns of nonaqueous solvent compositions shown in Tables 1 to 3, the % by volume of each nonaqueous solvent is shown in the upper part, and the volume ratio between the first solvent and the second solvent is shown in the lower part. In the column of electrolyte, the type and concentration (M (mol/L)) of the electrolyte used are shown. On the other hand, in the column of additive, components other than the nonaqueous solvent in the nonaqueous electrolyte and contents (% by weight) thereof are shown.

In the secondary batteries of Examples 2 to 5, 8 to 13, 16 to 19, and 21, the presence of Li₃N and a nitric acid compound at a part of the surface of the positive electrode current collector which faces the positive electrode active material-containing layer, was confirmed through the surface analysis described above. In addition, the presence of Li₃N and a nitric acid compound at a part of the surface of the positive electrode active material-containing layer was confirmed through the surface analysis described above.

On the other hand, in the secondary batteries of Examples 6, 7, 14, 15 and 22, the presence of a nitrogen-containing compound at a part of the surface of the positive electrode current collector which faces the positive electrode active material-containing layer, was confirmed through the surface analysis described above. In addition, the presence of a nitrogen-containing compound at a part of the surface of the positive electrode active material-containing layer was confirmed through the surface analysis described above. In the secondary battery of Example 20, the presence of a fluoride and a nitrogen-containing compound was confirmed at a part of the surface of the positive electrode current collector which faces the positive electrode active material-containing layer, and a part of the surface of the positive electrode active material-containing layer.

Details of the positive and negative electrode active materials used in the Examples will be described below.

The TiNb₂O₇ particles had a monoclinic structure, an average particle size of 1 μm, a BET specific surface area of 3 m²/g, and a Li insertion potential of 1 to 2 V (vs. Li/Li⁺).

The TiO₂ (B) particles had a monoclinic structure, an average particle size of 10 μm, a BET specific surface area of 10 m²/g, and a Li insertion potential of 1 to 2 V (vs. Li/Li⁺).

The Nb₁₆W₅O₅₅ particles had an average particle size of 1 μm, a BET specific surface area of 3 m²/g, and a Li insertion potential of 0.8 to 2.2 V (vs. Li/Li⁺).

The LiNi_{0.5}Co_{0.2}Mn_{0.3}O₂ particles had a layered structure and an average particle size of 3 μm.

The LiNi_{0.5}Co_{0.3}Mn_{0.2}O₂ particles had a layered structure and an average particle size of 3 μm.

### Comparative Examples 1 to 9

A thin nonaqueous electrolyte battery was produced in the same manner as described in Example 1 except for the nonaqueous solvent composition, the electrolyte, the negative electrode active material, the positive electrode active material, and the additive shown in the following Table 3. LiN(CF₃SO₂)₂ is lithium bistrifluoromethylsulfonylimide.

In the secondary battery of Comparative Example 1, the presence of Li₃N and a nitric acid compound at a part of the surface of the positive electrode current collector which faces the positive electrode active material-containing layer, was confirmed through the surface analysis described above. In addition, the presence of Li₃N and a nitric acid compound at a part of the surface of the positive electrode active material-containing layer was confirmed through the surface analysis described above. On the other hand, in the secondary batteries of Comparative Examples 2 to 9, no nitrogen-containing substance was present at the surface of the positive electrode current collector, and no nitrogen-containing substance was present at the surface of the positive electrode active material-containing layer.

### (Examples 23-29)

A thin nonaqueous electrolyte battery was produced in the same manner as described in Example 1 except for the nonaqueous solvent composition, the electrolyte, the negative electrode active material, the positive electrode active material, and the additive shown in the following Table 6. In the columns of nonaqueous solvent compositions shown in Table 6, the % by volume of each nonaqueous solvent is shown in the upper part, and the volume ratio between the first solvent and the second solvent is shown in the lower part. In the column of electrolyte, the type and concentration (M (mol/L)) of the electrolyte used are shown. On the other hand, in the column of additive, components other than the nonaqueous solvent in the nonaqueous electrolyte and contents (% by weight) thereof are shown.

Through performing the surface analysis on the secondary batteries of Examples 23-29, the presence of a substance containing boron (B) and fluorine (F) at a part of the surface of the positive electrode current collector which faces the positive electrode active material-containing layer was confirmed. Also, through the surface analysis, the presence of a boron-containing compound at a part of the surface of the positive electrode active material-containing layer was confirmed in Examples 23-29.

### <Test for Confirming Discharge Capacity and High Current Performance>

After the nonaqueous electrolyte batteries of the Examples and the Comparative Examples were charged up to 3.0 V at 25° C. and a constant current of 0.7 A, the discharge capacity when discharging was performed up to 1.5 V at 0.7 A was measured to obtain a discharge capacity at 25° C. Further, as a high current performance test, the batteries were charged up to 3.0 V at 25° C. and a constant current of 0.7 A, and then the discharge capacity when discharging was performed up to 1.5 V at 7 A was measured. The value of the discharge capacity at 7 A, when the discharge capacity at 0.7 A is taken as 100%, is shown in Tables 4 and 5 as a capacity retention ratio at 25° C. and 7 A.

### <High Temperature Cycle Test>

After the nonaqueous electrolyte batteries of the Examples and the Comparative Examples were charged up to 3.0 V at 70° C. and a constant current of 0.7 A, a cycle test of repeating discharging at a constant current of 0.7 A up to 1.5 V was performed. The number of cycles in which the discharge capacity reached 80% of the initial capacity in the cycle test is shown as a cycle life at 70° C. in Tables 4 and 5.

### <Low-Temperature Performance Test>

The discharge capacity of each of the nonaqueous electrolyte batteries of the Examples and the Comparative Examples at the time of discharging at −30° C. and 0.7 A was measured. The value of the discharge capacity at −30° C. and 0.7 A, when the discharge capacity at 25° C. and 0.7 A is taken as 100%, is shown in Tables 4 and 5 as a capacity retention ratio at −30° C.

TABLE 1

| | Nonaqueous solvent | | | | |
|---|---|---|---|---|---|
| | composition (% is % | | | | |
| | by volume) First | | | | |
| | solvent:second | | Positive electrode | Negative electrode | Additive |
| | solvent (volume ratio) | Electrolyte | active material | active material | (% is % by weight) |
| Example 1 | 70% EP/30% GBL 7:3 | 1.2M LiN(FSO₂)₂ | LiNi_{0.8}Co_{0.1}Mn_{0.1}O₂ | Li₄Ti₅O₁₂ | 1% LiNO₃, 1% PS |
| Example 2 | 70% PP/30% GBL 7:3 | 1.2M LiN(FSO₂)₂ | LiNi_{0.8}Co_{0.1}Mn_{0.1}O₂ | Li₄Ti₅O₁₂ | 1% LiNO₃, 1% PS |
| Example 3 | 70% EB/30% GBL 7:3 | 1.2M LiN(FSO₂)₂ | LiNi_{0.8}Co_{0.1}Mn_{0.1}O₂ | Li₄Ti₅O₁₂ | 1% LiNO₃, 1% PS |
| Example 4 | 80% PP/20% GBL 8:2 | 1.2M LiN(FSO₂)₂ | LiNi_{0.8}Co_{0.1}Mn_{0.1}O₂ | Li₄Ti₅O₁₂ | 1% LiNO₃, 1% PS |
| Example 5 | 50% PP/50% GBL 5:5 | 1.3M LiN(FSO₂)₂ | LiNi_{0.8}Co_{0.1}Mn_{0.1}O₂ | Li₄Ti₅O₁₂ | 0.3% LiNO₃, 1% PS |
| Example 6 | 50% PP/50% GBL 5:5 | 1.5M LiN(FSO₂)₂ | LiNi_{0.8}Co_{0.1}Mn_{0.1}O₂ | Li₄Ti₅O₁₂ | 1% PS |
| Example 7 | 40% EP/60% GBL 4:6 | 2M LiN(FSO₂)₂ | LiNi_{0.8}Co_{0.1}Mn_{0.1}O₂ | Li₄Ti₅O₁₂ | 1% PS, 1% FEC |
| Example 8 | 80% PP/20% GBL 8:2 | 1M LiN(FSO₂)₂ | LiNi_{0.8}Co_{0.1}Mn_{0.1}O₂ | Li₄Ti₅O₁₂ | 5% LiNO₃, 1% PS |
| Example 9 | 70% EP/30% GBL 7:3 | 1.2M LiN(FSO₂)₂ | LiNi_{0.8}Co_{0.1}Mn_{0.1}O₂ | TiNb₂O₇ | 1% LiNO₃, 1% PS |
| Example 10 | 70% PP/30% GBL 7:3 | 1.5M LiN(FSO₂)₂ | LiNi_{0.8}Co_{0.1}Mn_{0.1}O₂ | TiNb₂O₇ | 1% LiNO₃, 1% PS |

TABLE 2

| | Nonaqueous solvent | | | | |
|---|---|---|---|---|---|
| | composition (% is % | | | | |
| | by volume) First | | | | |
| | solvent:second | | Positive electrode | Negative electrode | Additive |
| | solvent (volume ratio) | Electrolyte | active material | active material | (% is % by weight) |
| Example 11 | 70% EB/30% GBL 7:3 | 1.2M LiN(FSO₂)₂ | LiNi_{0.8}Co_{0.1}Mn_{0.1}O₂ | TiNb₂O₇ | 1% LiNO₃, 1% PS |
| Example 12 | 80% PP/20% GBL 8:2 | 0.9M LiN(FSO₂)₂ | LiNi_{0.8}Co_{0.1}Mn_{0.1}O₂ | TiNb₂O₇ | 10% LiNO₃, 1% PS |
| Example 13 | 70% PP/20% GBL/ | 1.2M LiN(FSO₂)₃ | LiNi_{0.8}Co_{0.1}Mn_{0.1}O₂ | TiNb₂O₇ | 1% LiNO₃, 1% PS |
| | 10% PC 7:3 | | | | |
| Example 14 | 60% PP/20% GBL/ | 1.5M LiN(FSO₂)₃ | LiNi_{0.8}Co_{0.1}Mn_{0.1}O₂ | TiNb₂O₇ | — |
| | 20% PC 6:4 | | | | |
| Example 15 | 40% EP/40% GBL/ | 2 M LiN(FSO₂)₂ | LiNi_{0.8}Co_{0.1}Mn_{0.1}O₃ | TiNb₂O₇ | — |
| | 20% PC 4:6 | | | | |
| Example 16 | 70% EP/30% GBL 7:3 | 1.2M LiN(FSO₂)₂ | LiNi_{0.8}Co_{0.1}Mn_{0.1}O₃ | TiO₂(B) | 1% LiNO₃, 1% PS |
| Example 17 | 90% PP/10% GBL 9:1 | 1.2M LiN(FSO₂)₂ | LiNi_{0.8}Co_{0.1}Mn_{0.1}O₃ | TiNb₂O₇ | 1% LiNO₃, 1% PS |
| Example 18 | 20% EP/50% PP/ | 1.3M LiN(FSO₂)₂ | LiNi_{0.8}Co_{0.1}Mn_{0.1}O₃ | TiNb₂O₇ | 0.5% LiNO₃, 0.5% PS |
| | 30% GBL 7:3 | | | | |
| Example 19 | 70% PP/30% GBL 7:3 | 1.2M LiN(FSO₂)₂ | LiNi_{0.8}Co_{0.1}Mn_{0.1}O₂ | Nb₁₆W₅O₅₅ | 1% LiNO₃, 1% PS |

TABLE 3

| | Nonaqueous solvent | | | | |
|---|---|---|---|---|---|
| | composition (% is % | | | | |
| | by volume) First | | | | |
| | solvent:second | | Positive electrode | Negative electrode | Additive |
| | solvent (volume ratio) | Electrolyte | active material | active material | (% is % by weight) |
| Example 20 | 90% PP/20% GBL 8:2 | 1M LiN(FSO₂)₂ and | LiNi_{0.8}Co_{0.1}Mn_{0.1}O₂ | TiNb₂O₇ | 1% PS |
| | | 0.2M LiBF₄ | | | |
| Example 21 | 70% PP/30% GBL 7:3 | 1.2M LiN(FSO₂)₂ | LiNi_{0.8}Co_{0.2}Mn_{0.3}O₂ | TiNb₂O₇ | 1% LiNO₃, 1% PS |
| Example 22 | 70% PP/30% GBL 7:3 | 1. 5M LiN(FSO₂)₂ | LiNi_{0.8}Co_{0.3}Mn_{0.2}O₂ | TiNb₂O₇ | 1% PS |
| Comparative Example 1 | 100% GBL | 1.2M LiN(FSO₂)₂ | LiNi_{0.8}Co_{0.1}Mn_{0.2}O₂ | Li₄Ti₅O₁₂ | 1% LiNO₃, 1% PS |
| Comparative Example 2 | 100% EP | 1.2M LiN(FSO₂)₂ | LiNi_{0.8}Co_{0.1}Mn_{0.1}O₂ | Li₄Ti₅O₁₂ | — |
| Comparative Example 3 | 100% PP | 1.2M LiN(FSO₂)₂ | LiNi_{0.8}Co_{0.1}Mn_{0.1}O₂ | Li₄Ti₅O₁₇ | — |
| Comparative Example 4 | 100% EB | 1.2M LiN(FSO₂)₂ | LiNi_{0.8}Co_{0.1}MM_{0.1}O₂ | LisTi₅O₁₂ | — |
| Comparative Example 5 | 100% GBL | 1.2M LiBF₄ | LiNi_{0.8}Co_{0.1}Mn_{0.1}O₂ | Li₄Ti₅O₁₂ | — |
| Comparative Example 6 | 50% PC/50% PP | 1.2M LiPF₆ | LiNi_{0.8}Co_{0.1}Mn_{0.1}O₂ | Li₄Ti₅O₁₂ | — |
| Comparative Example 7 | 100% PC | 1.2M LiPF₆ | LiNi_{0.8}Co_{0.1}Mn_{0.1}O₂ | Li₄Ti₅O₁₂ | — |
| Comparative Example 8 | 100% DMC | 1.2M LiN(FSO₂)₂ | LiNi_{0.8}Co_{0.1}Mn_{0.1}O₂ | Li₄Ti₅O₁₂ | — |
| Comparative Example 9 | 100% PP | 1.2 M LiN(CF₃SO₂)₂ | LiNi_{0.8}Co_{0.1}Mn_{0.1}O₂ | Li₄Ti₅O₁₂ | — |

TABLE 4

| | Discharge | Capacity | Capacity | |
|---|---|---|---|---|
| | capacity | retention | retention | Cycle life |
| | (mAh) at | ratio (%) at | ratio (%) | (time) at |
| | 25° C. | 25° C. and 7 A | at −30° C. | 70° C. |
| Example 1 | 700 | 85 | 70 | 2000 |
| Example 2 | 700 | 85 | 80 | 2200 |
| Example 3 | 700 | 80 | 85 | 2200 |
| Example 4 | 710 | 83 | 85 | 2400 |
| Example 5 | 680 | 70 | 75 | 2200 |
| Example 6 | 700 | 85 | 80 | 2100 |
| Example 7 | 680 | 70 | 70 | 2000 |
| Example 8 | 680 | 70 | 80 | 2400 |
| Example 9 | 900 | 85 | 70 | 2000 |
| Example 10 | 910 | 90 | 85 | 2200 |
| Example 11 | 900 | 80 | 85 | 2200 |
| Example 12 | 900 | 75 | 80 | 2400 |
| Example 13 | 900 | 75 | 75 | 2600 |
| Example 14 | 910 | 88 | 85 | 2400 |
| Example 15 | 890 | 80 | 83 | 2300 |
| Example 16 | 780 | 70 | 70 | 2000 |
| Example 17 | 900 | 80 | 85 | 1800 |
| Example 18 | 880 | 85 | 80 | 2500 |
| Example 19 | 850 | 80 | 70 | 1700 |
| Example 20 | 850 | 70 | 70 | 2000 |

TABLE 5

| | | Capacity | | |
|---|---|---|---|---|
| | Discharge | retention | Capacity | Cycle |
| | capacity | ratio (%) | retention | life |
| | (mAh) at | at 25° C. | ratio (%) | (time) at |
| | 25° C. | and 7 A | at −30° C. | 70° C. |
| Example 21 | 820 | 85 | 75 | 2300 |
| Example 22 | 840 | 88 | 80 | 2200 |
| Comparative Example 1 | 300 | 30 | 35 | 50 |
| Comparative Example 2 | 400 | 40 | 40 | 150 |
| Comparative Example 3 | 300 | 30 | 40 | 100 |
| Comparative Example 4 | 250 | 30 | 30 | 100 |
| Comparative Example S | 100 | 20 | 20 | 100 |
| Comparative Example 6 | 500 | 50 | 50 | 200 |
| Comparative Example 7 | 300 | 10 | 30 | 300 |
| Comparative Example 8 | 200 | 20 | 0 | 50 |
| Comparative Example 9 | 250 | 30 | 40 | 40 |

TABLE 6

| | Nonaqueous solvent | | | | |
|---|---|---|---|---|---|
| | composition (% is % | | | | |
| | by volume) First | | | | |
| | solvent:second | | Positive electrode | Negative electrode | Additive |
| | solvent (volume ratio) | Electrolyte | active material | active material | (% is % by weight) |
| Example 23 | 70% PP/30% GBL 7:3 | 1.2M LiN(FSO₂)₂ | LiNi_{0.8}Co_{0.1}Mn_{0.1}O₂ | TiNb₂O₇ | 2% LiDFOB, 2% FEC |
| Example 24 | 30% PP/70% GBL 3:7 | 1.2M LiN(FSO₂)₂ | LiNi_{0.8}Co_{0.1}Mn_{0.1}O₂ | TiNb₂O₇ | 2% LiDFOB, 5% FEC, |
| | | | | | 1% PS |
| Example 25 | 70% EP/30% GBL 7:3 | 1.2M LiN(FSO₂)₂ | LiNi_{0.8}Co_{0.1}Mn_{0.1}O₂ | TiNb₂O₇ | 2% LiDFOB, 2% FEC |
| Example 26 | 30% EP/70% GBL 3:7 | 1.2M LiN(FSO₂)₂ | LiNi_{0.8}Co_{0.1}Mn_{0.1}O₂ | TiNb₂O₇ | 2% LiDFOB, 5% FEC, |
| | | | | | 1% PS |
| Example 27 | 70% PP/30% GBL 7:3 | 1.2M LiN(FSO₂)₂ | LiNi_{0.8}Co_{0.1}Mn_{0.1}O₂ | TiNb₂O₇ | 2% LiBF₄, 2% FEC |
| Example 28 | 30% PP/50% GBL/20% PC 3:7 | 1.2M LiN(FSO₂)₂ | LiNi_{0.8}Co_{0.1}Mn_{0.1}O₂ | TiNb₂O₇ | 2% LiDFOB, 5% FEC, |
| | | | | | 1% PS |
| Example 29 | 30% EP/50% GBL/20% PC 3:7 | 1.2M LiN(FSO₂)₂ | LiNi_{0.8}Co_{0.1}Mn_{0.1}O₂ | TiNb₂O₇ | 2% LiDFOB, 5% FEC, |
| | | | | | 1% PS |

TABLE 7

| | Discharge | Capacity | Capacity | |
|---|---|---|---|---|
| | capacity | retention | retention | Cycle life |
| | (mAh) at | ratio (%) at | ratio (%) | (time) at |
| | 25° C. | 25° C. and 7 A | at −30° C. | 70° C. |
| Example 23 | 910 | 86 | 86 | 2500 |
| Example 24 | 900 | 83 | 80 | 2700 |
| Example 25 | 920 | 87 | 80 | 2400 |
| Example 26 | 910 | 88 | 82 | 2300 |
| Example 27 | 900 | 85 | 80 | 2100 |
| Example 28 | 910 | 83 | 73 | 3000 |
| Example 29 | 920 | 86 | 75 | 2900 |

As is apparent from Table 1 to 5, the batteries of Examples 1 to 22 are excellent in discharge capacity at a low temperature of −30° C., capacity retention ratio in a high current discharge of 7 A, and cycle life at 70° C. as compared with the batteries of Comparative Examples 1 to 9. In particular, in Examples 4, 9, 10, 11, 12, 13, 14, 17, and 18, excellent performance was obtained in all of the discharge performance at −30° C., the high current discharge performance at 7 A, and the high-temperature cycle life performance at 70° C. This is because the nonaqueous electrolyte used in each of the Examples is excellent in low-temperature discharge performance and excellent in high-temperature stability and life.

As is apparent from Tables 6 and 7, the batteries of Examples 23 to 29 are excellent in discharge capacity at a low temperature of −30° C., capacity retention ratio in a high current discharge of 7 A, and cycle life at 70° C. as compared with the batteries of Comparative Examples 1 to 9. If a comparison is made between Example 9 and Example 25 in which the nonaqueous solvent composition, the electrolyte, the positive electrode active material, and the negative electrode active material were of the same type, the battery of Example 25 is excellent in discharge capacity at a low temperature of −30° C., capacity retention ratio in a high current discharge of 7 A, and cycle life at 70° C. as compared with the battery of Example 9. In the battery of Example 25, the nonaqueous electrolyte contains a boron-containing compound and a fluorine-containing compound. Therefore, it can be inferred that the substance (film) present at the surface of the positive electrode current collector has high stability, and is excellent in the corrosion suppressing effect of the positive electrode current collector.

On the other hand, in the battery of Comparative Example 1, a nitrogen-containing substance was present at the surface of the positive electrode current collector, but the nonaqueous electrolyte had a high viscosity and poor ion conductivity, and thus all of the discharge performance at −30° C., the high current discharge performance at 7 A, and the high-temperature cycle life performance at 70° C. were low. In addition, in the batteries of Comparative Examples 2 to 4 and 8, since the ion dissociation of LiFSI decreases and the ionic conductivity decreases, all of the discharge performance at −30° C., the high current discharge performance at 7 A, and the high-temperature cycle life performance at 70° C. were low. On the other hand, in the batteries of Comparative Examples 5 to 7 and 9, no nitrogen-containing substance or a substance containing any one of N, B, or F was formed at the surface of the positive electrode current collector. Therefore, the corrosion of the positive electrode current collector proceeded, and all of the discharge performance at −30° C., the high current discharge performance at 7 A, and the high-temperature cycle life performance at 70° C. were low. LiN(CF₃SO₂)₂ used in Comparative Example 9 did not form a nitrogen-containing substance or a substance containing any one of N, B, or F. As a result, the positive electrode current collector was corroded, and the cycle life was reduced.

The secondary battery of at least one of the embodiments or Examples described above includes a nonaqueous electrolyte containing a nonaqueous solvent containing a first solvent including at least one selected from the group consisting of EP, PP, and EB and a second solvent including GBL, and an electrolyte containing LiFSI, and thus can realize a secondary battery that is excellent in high current performance, low-temperature performance, and high-temperature life performance.

Hereinafter, the inventions of the embodiments will be additionally described.
(1)

A secondary battery including:
a positive electrode;
a negative electrode; and
a nonaqueous electrolyte containing a nonaqueous solvent and an electrolyte, the nonaqueous solvent containing a first solvent including at least one selected from the group consisting of ethyl propionate, propyl propionate and ethyl butyrate, and a second solvent including γ-butyrolactone, and the electrolyte containing lithium bisfluorosulfonylimide.
(2)

The secondary battery according to (1), wherein the nonaqueous electrolyte further contains at least one selected from the group consisting of a nitrogen-containing compound, a sulfur-containing compound, a boron-containing compound, a phosphorus-containing compound, and a fluorine-containing compound.
(3)

The secondary battery according to (1) or (2), wherein the nonaqueous electrolyte further contains at least one selected from the group consisting of 1,3-propane sultone, fluoroethylene carbonate, tris(trimethylsilyl) phosphate, a nitrate, a lithium difluoro (oxalate) borate, and lithium tetrafluoroborate.
(4)

The secondary battery according to (1) or (2), wherein the nonaqueous electrolyte further contains at least one selected from the group consisting of 1,3-propane sultone, fluoroethylene carbonate, and tris(trimethylsilyl) phosphate.
(5)

The secondary battery according to any one of (1) to (4), wherein the positive electrode includes a positive electrode current collector containing at least one of aluminum or an aluminum alloy and a nitrogen-containing substance that is present at at least a part of a surface of the positive electrode current collector.
(6)

The secondary battery according to any one of (1) to (5), wherein
the positive electrode contains a positive electrode current collector including at least one of aluminum or an aluminum alloy, and a substance containing at least one element selected from the group consisting of N, B, and F being present at at least a part of a surface of the positive electrode current collector.
(7)

The secondary battery according to any one of (1) to (6), wherein the negative electrode contains a negative electrode active material containing at least one of a titanium-containing oxide or a niobium-containing oxide.
(8)

The secondary battery according to any one of (1) to (7), wherein the negative electrode contains a negative electrode active material containing at least one selected from the group consisting of a lithium titanium-containing oxide, a titanium oxide, a niobium titanium-containing oxide, a niobium tungsten-containing oxide, and a niobium titanium molybdenum-containing oxide.
(9)

The secondary battery according to any one of (1) to (8), wherein the negative electrode contains a negative electrode active material containing at least one of Li_{4/3+a}TiO_{5/3}O₄ (0≤a≤2) or Li_{c}TiNb_{d}O₇(0≤c≤5 and 1≤d≤4).
(10)

A battery pack including the secondary battery according to any one of (1) to (9).
(11)

The battery pack according to (10), further including:
an external power distribution terminal; and
a protective circuit.
(12)

The battery pack according to (10) or (11), further including
a plurality of the secondary battery,
the secondary batteries being electrically connected in series, in parallel, or in a combination of in series and in parallel.
(13)

A vehicle including the battery pack according to any one of (10) to (12).
(14)

The vehicle according to (13), including a mechanism configured to convert kinetic energy of the vehicle into regenerative energy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery comprising:
a positive electrode;
a negative electrode; and
a nonaqueous electrolyte comprising a nonaqueous solvent and an electrolyte, the nonaqueous solvent comprising a first solvent including at least one selected from the group consisting of ethyl propionate, propyl propionate and ethyl butyrate and a second solvent including γ-butyrolactone, and the electrolyte comprising lithium bisfluorosulfonylimide.

2. The secondary battery according to claim 1, wherein the nonaqueous electrolyte further comprises at least one selected from the group consisting of a nitrogen-containing compound, a sulfur-containing compound, a boron-containing compound, a phosphorus-containing compound, and a fluorine-containing compound.

3. The secondary battery according to claim 1, wherein the nonaqueous electrolyte further comprises at least one selected from the group consisting of 1,3-propane sultone, fluoroethylene carbonate, tris(trimethylsilyl) phosphate, a nitrate, a lithium difluoro (oxalate) borate, and lithium tetrafluoroborate.

4. The secondary battery according to claim 1, wherein the positive electrode comprises
a positive electrode current collector comprising at least one of aluminum or an aluminum alloy and
a nitrogen-containing substance that is present at at least a part of a surface of the positive electrode current collector.

5. The secondary battery according to claim 1, wherein the positive electrode comprises
a positive electrode current collector comprising at least one of aluminum or an aluminum alloy, and
a substance containing at least one element selected from the group consisting of N, B, and F being present at at least a part of a surface of the positive electrode current collector.

6. The secondary battery according to claim 1, wherein the negative electrode contains a negative electrode active material comprising at least one of a titanium-containing oxide or a niobium-containing oxide.

7. The secondary battery according to claim 1, wherein the negative electrode contains a negative electrode active material comprising at least one selected from the group consisting of a lithium titanium-containing oxide, a titanium oxide, a niobium titanium-containing oxide, a niobium tungsten-containing oxide, and a niobium titanium molybdenum-containing oxide.

8. The secondary battery according to claim 1, wherein the negative electrode contains a negative electrode active material comprising at least one of Li_{4/3+a}Ti_{5/3}O₄ (0≤a≤2) or Li_{c}TiNb_{d}O₇(0≤c≤5 and 1≤d≤4).

9. A battery pack comprising the secondary battery according to claim 1.

10. The battery pack according to claim 9, further comprising:
an external power distribution terminal; and
a protective circuit.

11. The battery pack according to claim 10, further comprising
a plurality of secondary batteries,
the secondary batteries being electrically connected in series, in parallel, or in a combination of in series and in parallel.

12. A vehicle comprising the battery pack according to claim 9.

13. The vehicle according to claim 12, comprising a mechanism configured to convert kinetic energy of the vehicle into regenerative energy.
